(19) United States
(12) Patent Application Publication
(10) Pub. No.: US 2025/0233884 A1
(43) Pub. Date: Jul. 17, 2025

(54) Exposure and Attack Surface Management Using a Data Fabric

(71) Applicant: Avalor Technologies, Ltd., Tel Aviv (IL)

(72) Inventors: Noam Sherr Lurie, Ramat Gan (IL); Liron Tal, Azur (IL); Noga Anaby, New York, NY (US); Gal Duan, Rishon LeZion (IL); Amit Witkovski, Rishon LeZion (IL); Hili Bar On, Tel Aviv (IL); Kfir Tishbi, Herzliya (IL)

(73) Assignee: Avalor Technologies, Ltd., Tel Aviv (IL)

(21) Appl. No.: 19/170,332

(22) Filed: Apr. 4, 2025

Related U.S. Application Data
(63) Continuation-in-part of application No. 18/940,065, filed on Nov. 7, 2024.
(63) Continuation-in-part of application No. 18/176,151, filed on Feb. 28, 2023.

(51) Int. Cl. H04L 9/40; H04L 43/045

(52) U.S. Cl. CPC H04L 63/1433; H04L 43/045; H04L 63/1466

(57) ABSTRACT

The disclosed embodiments provide systems and methods for continuous exposure and attack surface management using a data fabric. Data from multiple heterogeneous cybersecurity sources, including vulnerability scanners, threat intelligence, cloud security tools, and endpoint monitoring systems, is ingested and integrated into a semantically harmonized representation, such as a security knowledge graph. This unified data model normalizes, correlates, and contextualizes diverse cybersecurity information, enabling comprehensive and real-time assessment of an organization's cybersecurity risk posture. Automated workflows trigger proactive remediation actions based on dynamically calculated exposure metrics. Additional embodiments leverage the same data fabric architecture to support specialized cybersecurity use cases, including unified vulnerability management (UVM), cyber asset attack surface management (CAASM), continuous threat exposure management (CTEM), and asset exposure management (AEM).

### CROSS-REFERENCE TO RELATED APPLICATION(S)

The present disclosure is a continuation-in-part of the following applications and the contents of each are incorporated by reference in their entirety:
(1) U.S. patent application Ser. No. 18/940,065, filed Nov. 7, 2024, and entitled “Cloud Unified Vulnerability Management Generating Unified Cybersecurity Signals from Multiple Sources,” and
(2) U.S. patent application Ser. No. 18/176,151, filed Feb. 28, 2023, and entitled “Techniques for the unification of raw cyber data collected from different sources for vulnerability management.”

### FIELD OF THE DISCLOSURE

The present disclosure relates generally to cybersecurity. More particularly, the present disclosure relates to systems and methods for exposure and attack surface management using a data fabric.

### BACKGROUND OF THE DISCLOSURE

Security and information technology (IT) teams today face significant challenges in managing an extensive range of digital assets, often utilizing multiple platforms that operate independently and in isolated silos. This fragmented approach leads to an absence of a unified, comprehensive asset inventory, severely limiting visibility across the entire organizational landscape. Without a centralized and accurate asset inventory, teams encounter heightened exposure to cybersecurity threats because vulnerabilities, misconfigurations, and security gaps frequently remain undetected and unresolved. Even basic security tasks, such as determining which assets have endpoint detection and response (EDR) solutions installed or verifying up-to-date patch status, become complex and resource-intensive. Conventional systems aimed at addressing these issues, such as continuous threat exposure management (CTEM), asset exposure management (AEM), and cyber asset attack surface management (CAASM), often provide incomplete or fragmented views. These conventional approaches typically suffer from limited integration capabilities, resulting in incomplete asset data, reduced contextual insight, and inefficient risk prioritization. Consequently, organizations must invest significant time and resources merely to identify and evaluate risks accurately, leading to delayed mitigation and an increased window of vulnerability to potential attacks.

### BRIEF SUMMARY OF THE DISCLOSURE

In an embodiment, a data fabric-based approach is utilized to significantly enhance asset visibility and management consistency within the organization's cybersecurity and IT infrastructure. The data fabric integrates seamlessly across numerous existing security and IT platforms through robust application programming interfaces (APIs) and connectors, enabling the aggregation of asset data previously isolated within separate, disconnected systems. This integration creates a unified, dynamically updated, and enriched asset inventory, known as a high-fidelity “golden record,” providing authoritative, real-time, and comprehensive insights into the organization's entire asset landscape. This golden record is continuously refined through entity resolution processes, consolidating conflicting or duplicated asset data from multiple sources into a single, trustworthy inventory.

The data fabric delivers substantial benefits, such as establishing an asset inventory organizations can confidently rely upon by aggregating and resolving asset data across dozens of disparate source systems. It helps close coverage gaps by correlating detailed asset information, enabling cybersecurity teams to swiftly identify and remediate missing coverage or misconfigurations, enforce compliance requirements, and eliminate blind spots in asset monitoring. Additionally, the data fabric supports the dynamic identification and proactive mitigation of risks, ensuring that asset coverage gaps are promptly recognized and addressed. By providing enriched, real-time asset information, the data fabric facilitates the precise prioritization and implementation of risk mitigation policies, activating rapid responses to emerging threats. Ultimately, this reduces the organization's overall attack surface and enhances cybersecurity resilience.

In another embodiment, the present disclosure relates to systems and methods for cloud unified vulnerability management (UVM) generating a unified cybersecurity signal from multiple sources. This approach enhances threat management by consolidating signals from multiple, independent monitoring systems to create a unified cybersecurity object. The process involves receiving cybersecurity signals from two distinct monitoring systems within a computing environment, each tracking potential threats. By integrating these signals, the method generates a single object that reflects the combined data, which is then analyzed to determine the severity level of the threat. This unified approach improves threat visibility, prioritization, and response across disparate security tools, supporting better-informed decision-making in cybersecurity.

### BRIEF DESCRIPTION OF THE DRAWINGS

The present disclosure is detailed through various drawings, where like components or steps are indicated by identical reference numbers for clarity and consistency.

FIG. 1 illustrates an example network diagram of a computing environment monitored by a plurality of cybersecurity monitoring systems.

FIG. 2 illustrates an example graph representing the computing environment from a plurality of sources.

FIG. 3 illustrates an example schematic illustration of an uber node of a representation graph.

FIG. 4 illustrates an example flowchart of a method for generating a unified cybersecurity object.

FIG. 5 illustrates an example flowchart of a method for representing tickets of a cybersecurity ticketing system.

FIG. 6 illustrates an example flowchart of a method for maintaining digital asset status.

FIG. 7 illustrates an example flowchart of a method for initiating monitoring of a computing environment based on a scan result from another monitoring system.

FIG. 8 illustrates a flowchart of existing tools collecting data, analyzing risk with the tool's narrow focus, and providing reports.

FIG. 9 illustrates a flowchart of a transformative approach to risk management by consolidating security data, compared to the approach in FIG. 8.

FIG. 10 illustrates a functional diagram of a data fabric implemented using a security knowledge graph based on the various techniques described herein.

FIG. 11 illustrates a cloud-based system integrated with the data fabric.

FIG. 12 illustrates a block diagram of a computing device.

FIG. 13 illustrates an example implementation of an asset visibility and management system connected to and configured to monitor the computing environment in FIG. 1.

FIG. 14 illustrates the data fabric for providing the asset visibility and management system.

FIG. 15 illustrates how the data fabric works in tandem with the AEM application to consolidate and interpret critical asset data from a wide range of sources.

FIG. 16 illustrates an architecture with building blocks over the data fabric for asset management and policy enforcement.

FIG. 17 illustrates a workflow pipeline composed of three primary sequential stages: Trigger, Execution, and Outcome for policies in the AEM application.

FIG. 18 illustrates a user interface for creating a new security policy in an asset or cybersecurity management platform.

FIG. 19 illustrates a conceptual workflow for calculating policy violations within the data fabric.

FIG. 20 illustrates the detailed workflow for creating, updating, and managing policy rules and their associated violation metrics in a data-driven system.

FIGS. 21A-21C illustrates user interfaces showing variations in the filtering structures used for different cybersecurity policy categories within a security management system.

FIG. 22 illustrates a user interface with a dynamic aging rule mechanism used for cybersecurity policy management.

FIGS. 23A-23B illustrate widgets presented in a user interface, including a trend line widget (FIG. 23A) and a progress bar tile widget (FIG. 23B).

FIGS. 24A-24B illustrate example widgets presented within a user interface, specifically including a Multi-dimension Line widget (FIG. 24A) and a Table Widget Column formatter (FIG. 24B).

FIG. 25 illustrates a user interface displaying example Venn diagrams.

FIG. 26 illustrates a Policy Compliance Dashboard designed to monitor the state of various policies defined within an account.

FIG. 27 illustrates an Asset Inventory Dashboard designed to provide a comprehensive view of all organizational assets.

FIG. 28 illustrates a user interface featuring formatting rules intended to enhance metric visualization within widgets.

FIG. 29 illustrates an example flowchart of a computer-implemented method for continuous exposure and attack surface management in an enterprise computing environment using a unified, integrated approach enabled by a data fabric.

### DETAILED DESCRIPTION OF THE DISCLOSURE

Again, in an embodiment, the present disclosure relates to systems and methods for exposure and attack surface management using a data fabric. Also, the present disclosure includes cloud UVM for identifying, assessing, and mitigating security vulnerabilities across an organization's IT environment, via the data fabric. The data fabric aggregates and correlates data from over hundreds of sources, including traditional vulnerability feeds, asset details, application security findings, and user behavior. This integration provides a holistic view of potential threats, enabling organizations to prioritize risks based on contextual insights and mitigating controls. The present disclosure automates remediation workflows, streamlining the process of addressing vulnerabilities, and features dynamic reporting and dashboards that offer real-time insights into security posture and team performance.

The disclosed embodiments include a method and system for unifying cybersecurity data for threat management using multiple cybersecurity monitoring systems. In one embodiment, each cybersecurity monitoring system collects data from various scanners or sources. For instance, a first scanner from a first cybersecurity system and a second scanner from a second cybersecurity system can both provide data related to a resource deployed in a cloud computing environment. In an embodiment, a cybersecurity threat is detected by the first scanner but not by the second cybersecurity monitoring system. In some cases, the second cybersecurity monitoring system may be prompted to scan the resource for the detected threat in response to the first scanner's detection. In other embodiments, a cybersecurity threat is detected on a resource at a specific time. Information about the resource, the threat, or both is then stored in a representation graph. In one embodiment, an entry is removed from the representation graph after a certain time period has passed. In some cases, the entry is removed if a scan from a cybersecurity monitoring system at a later time shows that the threat is no longer detected.

It is understood that while a human operator can initiate the storage of information related to resources and receive such information from multiple sources, they are not capable of processing the volume of data provided by a single scanner in a cloud environment with hundreds of resources and principals, let alone aggregating data from multiple scanners across different cybersecurity systems. Even if a human could somehow access all this data, it would be impossible to manually cross-reference it to detect and unify data related to the same resource from various cybersecurity monitoring systems in real-time as new scan data arrives. A human lacks the capacity for this cross-referencing due to the need for consistent and objective matching criteria, something the human mind is not equipped to handle. The system described here addresses this limitation by applying matching rules in a consistent, objective manner, such as determining when data from different scanners pertains to the same resource in a cloud computing environment.

Specifically, there are a significant number of tools generating data, but there are lots of questions that cannot be answered for chief information security officers (CISO)—
(1) How vulnerable are our most critical applications?
(2) Are endpoint agents installed everywhere they should be?
(3) How many assets do we really have?
(4) How has our risk posture changed since we last checked?

The reason why it is so difficult to understand risk posture is because data lives in silos, i.e. individual tools, whereas intelligence is in a black box.

### Example Computing Environment

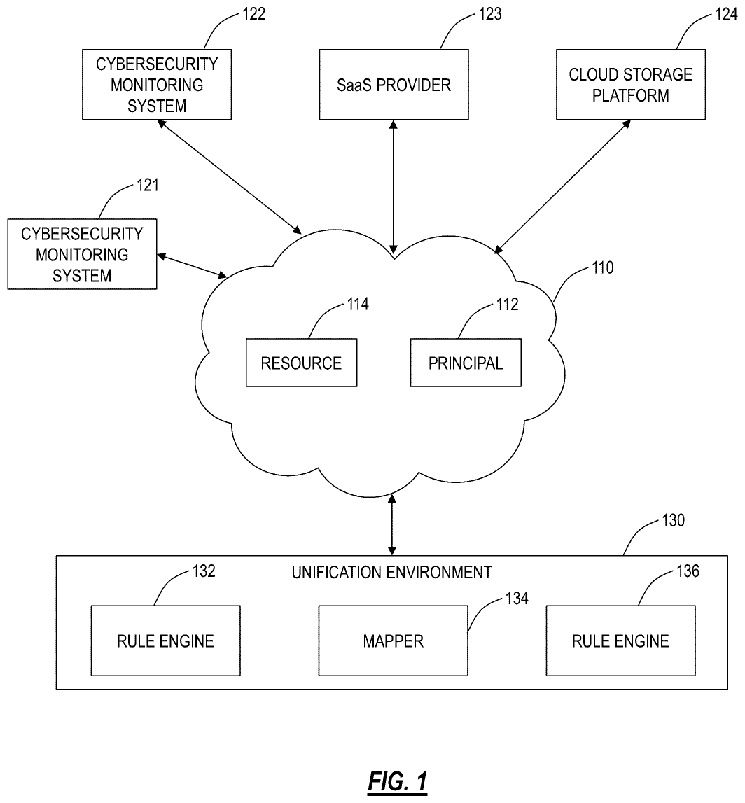

FIG. 1 illustrates an example network diagram of a computing environment 110 monitored by a plurality of cybersecurity monitoring systems. In an embodiment, the computing environment 110 includes a cloud computing environment, a local computing environment, a hybrid computing environment, and the like, as well as combinations thereof. For example, in some embodiments, a cloud computing environment is implemented on a cloud computing infrastructure. For example, the cloud computing environment is a virtual private cloud (VPC) implemented on Amazon® Web Services (AWS), a virtual network (VNet) implemented on Microsoft® Azure, and the like. In an embodiment, the cloud computing environment includes multiple environments of an organization. For example, a cloud computing environment includes, according to an embodiment, a production environment, a staging environment, a testing environment, and the like. Specifically, the computing environment 110 includes all IT resources of an enterprise, company, organization, etc.

In certain embodiments, the computing environment 110 includes entities, such as resource and principals. A resource 114 is, for example, a hardware resource, a software resource, a computer, a server, a virtual machine, a serverless function, a software container, an asset, a combination thereof, and the like. In an embodiment, a resource 114 exposes a hardware resource, provides a service, provides access to a service, a combination thereof, and the like. For example, the resource 114 can be an endpoint. In some embodiments, a principal 112 is authorized to act on a resource 114. For example, in a cloud computing environment, a principal 112 is authorized to initiate actions in the cloud computing environment, act on the resource 114, and the like. The principal 112 is, according to an embodiment, a user account, a service account, a role, and the like. In some embodiments, a resource 114 is deployed in a production environment, and another resource (not shown) which corresponds to the resource 114 is deployed in a staging environment. This is utilized, for example, when testing the performance of a resource in an environment which is similar to the production environment. Having multiple computing environments 110, where each environment corresponds to at least another computing environment, is a principal of software development and deployment known as continuous integration/continuous deployment (CI/CD).

In an embodiment, the computing environment 110 is communicatively coupled with a first cybersecurity monitoring system 121, a second cybersecurity monitoring system 122, a security-as-a-service (SaaS) provider 123, a cloud storage platform 124, and the like. A cybersecurity monitoring system includes, for example, scanners and the like, configured to monitor the computing environment 110 for cybersecurity threats such as malware, exposures, vulnerabilities, misconfigurations, posture, policy, and the like. In some embodiments, having multiple cybersecurity monitoring systems 121, 122 is advantageous, as each cybersecurity monitoring systems 121, 122 may be configured to provide different capabilities, such as scanning for different types of cybersecurity threats.

For illustrative purposes, FIG. 1 includes two cybersecurity monitoring systems 121, 122, but those skilled in the art will appreciate there can be multiplex different systems. Cybersecurity monitoring systems encompass a range of tools designed to protect an organization's infrastructure by continuously detecting, preventing, and responding to threats across different environments. Intrusion detection and prevention systems (IDS/IPS) focus on identifying and blocking suspicious network activity, while security information and event management (SIEM) systems aggregate data from multiple sources to identify threat patterns. Endpoint detection and response (EDR) solutions monitor endpoint devices for malicious activity, providing rapid response capabilities, whereas external attack surface management (EASM) tools continuously monitor external assets to identify vulnerabilities that could be exploited by attackers. Network traffic analysis (NTA) tools detect unusual network patterns, and vulnerability management systems identify security weaknesses within systems. For cloud environments, cloud security monitoring ensures compliance and identifies cloud-specific threats. Threat intelligence platforms (TIP) provide insights into emerging threats, while user and entity behavior analytics (UEBA) detect insider threats through behavioral analysis. Finally, application security monitoring tools focus on identifying vulnerabilities in applications and application programming interfaces (APIs). Together, these systems create a multi-layered defense, improving an organization's ability to respond to diverse cybersecurity risks. The present disclosure contemplates the cybersecurity monitoring systems 121, 122 being any of these or any other tool for cybersecurity monitoring.

Each of the first cybersecurity monitoring system 121, the second cybersecurity monitoring system 122, the SaaS provider 123, the cloud storage platform 124, and the like, are configured to interact with the computing environment 110. For example, the cybersecurity monitoring systems 121, 122 are configured to monitor assets, such as resources 114 (endpoints) of the computing environment 110. Each cybersecurity monitoring system 121, 122 which interacts with the computing environment 110 has data, metadata, and the like, which the cybersecurity monitoring system 121, 122 utilizes for interacting with the computing environment 110. For example, the cybersecurity monitoring system 121, 122 is configured to store a representation of the computing environment 110, for example as a data model which includes detected cybersecurity threats. Such a representation, model, and the like, is a source, for example for modeling the computing environment 110. In some embodiments, a source provides data, for example as a data stream, including records, events, and the like. For example, a data stream includes, according to an embodiment, a record of a change to the computing environment 110, an event indicating detection of the change, communication between resources, communication between a principal and a resource, communication between principals, combinations thereof, and the like.

In an embodiment, a SaaS provider 123 is implemented as a computing environment which provides software as a service, for example a client relationship management (CRM) software, a sales management software, and the like. The SaaS provider 123 delivers cloud-based applications over the internet, enabling access to software without the need for local installation or management of infrastructure. These providers 123 host the application, backend infrastructure, data, and updates, allowing users to access and use the software directly through a web browser. The SaaS providers 123 typically operate on a subscription model, where customers pay for the service monthly or annually. This approach offers flexibility, scalability, and cost-efficiency, as organizations can use high-quality software without the costs associated with maintaining hardware or managing software updates.

In some embodiments, a cloud storage platform 124 is implemented as a cloud computing environment which provides a service to the computing environment 110. For example, in certain embodiments, the cloud storage platform 124 is a storage service, such as Amazon® Simple Storage Solution (S3). The cloud storage platform 124 is an online service that enables users and organizations to store, manage, and access data over the internet rather than on local devices or on-premises servers. It works by saving data on remote servers, maintained and managed by the service provider, who handles tasks like security, maintenance, backups, and updates. Users can access their stored data anytime from any device with internet access, providing flexibility and scalability for both personal and enterprise needs. Cloud storage platforms typically offer several service models, including free, pay-as-you-go, and subscription-based options, depending on storage requirements. Some examples include Google Drive, Dropbox, Microsoft OneDrive, and Amazon S3.

Those skilled in the art will recognize the computing environment 110 represents all of the computing resources associated with an organization, company, enterprise, etc. The computing environment 110 in FIG. 1 is presented for illustration purposes. Generally, the computing environment 110 includes an interconnected network of devices, applications, and servers that handle a variety of tasks, from managing internal data to serving customer-facing services. This computing environment 110 includes endpoint devices like computers and mobile devices, network infrastructure such as routers and switches, data storage systems, cloud resources, and various applications—both on-premises and cloud-based—that facilitate business operations. Each of these components is essential for maintaining the organization's daily workflows, data access, and communication. As enterprises expand, so does the complexity of their computing environment 110, creating numerous potential points of vulnerability. The cybersecurity monitoring systems 121, 122 are necessary to protect these environments 110 because they provide real-time oversight and detect unusual patterns or behaviors that may indicate a threat. Effective monitoring can help identify issues like unauthorized access, malware, insider threats, and data exfiltration attempts before they result in significant damage or data breaches. Given the growing sophistication of cyber threats, monitoring helps ensure that the enterprise maintains business continuity, protects sensitive data, and complies with regulatory requirements, safeguarding both the organization's assets and its reputation.

### UVM Unification Environment

In an embodiment, a unification environment 130 is communicatively coupled with the computing environment 110. In certain embodiments, the unification environment 130 is configured to receive data from a plurality of sources, such as the cloud storage platform 124, the SaaS provider 123, and the cybersecurity monitoring systems 121, 122. The unification environment 130 includes a rule engine 132, a mapper 134, and a graph database 136. In some embodiments, a rule engine 132 is deployed on a virtual machine, software container, serverless function, combination thereof, and the like. In an embodiment, the mapper 134 is configured to receive data from a plurality of sources, and store the data based on at least a predefined data structure (e.g., of a graph) in the graph database 136. The graph database 136 is, in an embodiment, Neo4j®, for example. In some embodiments, the predefined data structure includes a plurality of data fields, each data field configured to store at least a data value. The unification environment 130 can be a SaaS or cloud service to perform UVM as described herein.

In certain embodiments, the data structure is a dynamic data structure. A dynamic structure is a data structure which changes based on an input. For example, in certain embodiments a source provides a data field which is not part of the predefined data structure of a graph stored in the graph database 136. In such embodiments, the mapper 134 is configured to redefine the predefined data structure to include the data field which was not previously part of the predefined data structure. In some embodiments, the mapper 134 is configured to map a data field of a first source and a data field of a second source to a single data field of the predefined data structure. An example of such mapping is discussed in more detail with respect to FIG. 3 below. In certain embodiments, the mapper 134 is configured to store a mapping table which indicates, for each data source, a mapping between a data field of the source and a data field of a predefined data structure of the graph stored in the graph database 136.

The graph database 136 is configured to store a representation of data from a plurality of data sources, each data source representing, interacting with, and the like, the computing environment 110, according to an embodiment. For example, in some embodiments, the graph database 136 is configured to store a representation of principals 112, resources 114, events, enrichments, and the like. In some embodiments, the mapper 134 is configured to utilize a rule engine 132 to determine which data field from a first source is mapped to a data field of the predefined data structure. In certain embodiments, the rule engine 132 includes a rule which is utilized by the mapper 134 to determine what data to store in a data conflict event. In some embodiments the rule engine 132 is configured to store a rule, a policy, combinations thereof, and the like. In certain embodiments, the rule engine 132 is a multi-tenant rule engine, serving a plurality of computing environments 110. In such embodiments, the rule engine 132 is configured to apply rules per tenant, for each of the plurality of computing environments 110. For example, a first tenant utilizes a first source mapped using a first mapping, while a second tenant utilizes the first source mapped using a second mapping.

In certain embodiments, the rule engine 132 includes a control. A control is a rule, condition, and the like, which is applied to an entity of the computing environment 110. An entity is, for example, a principal 112, a resource 114, an event, and the like, according to an embodiment. In some embodiments, the control is implemented using a logic expression, such as a Boolean logic expression. For example, in an embodiment, a control includes an expression such as “NO ‘Virtual Machine’ HAVING ‘Operating System’ EQUAL ‘Windows 7’”. In some embodiments, the rule engine 132 is configured to traverse the graph stored in the graph database 136 to determine if a representation stored thereon violates a control.

### Graph

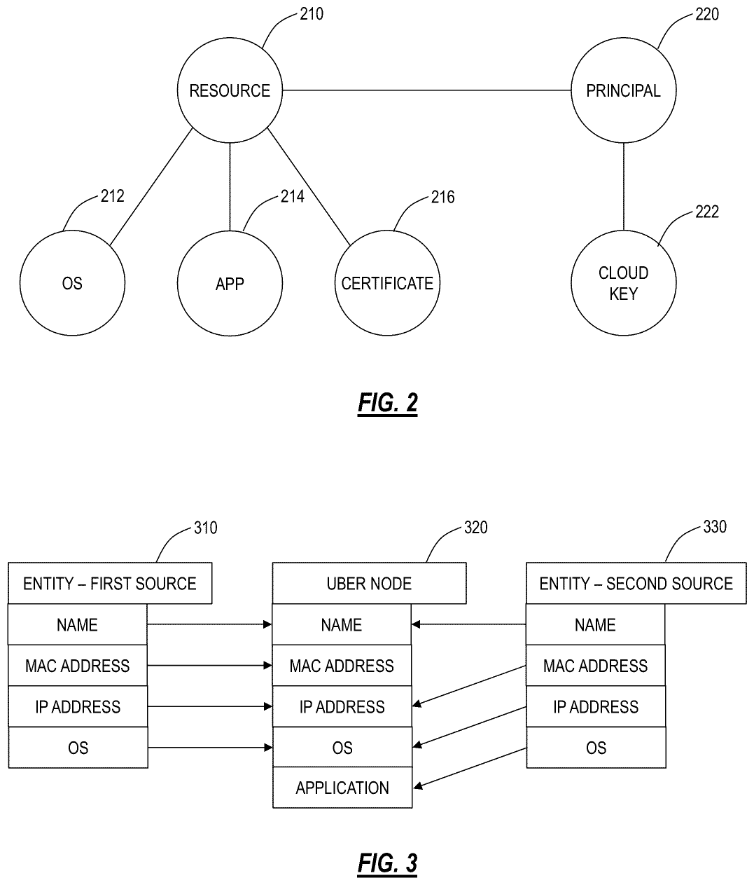

FIG. 2 illustrates an example graph representing the computing environment 110 from a plurality of sources, implemented in accordance with an embodiment. In an embodiment, the computing environment 110 is monitored by a plurality of cybersecurity monitoring systems. For example, in an embodiment a cloud computing environment is monitored by a first cybersecurity monitoring system (e.g., Snyk®), and a second cybersecurity monitoring system (e.g., Rapid7®). The plurality of cybersecurity monitoring systems differ from each other, for example by monitoring different cybersecurity threats, monitoring different assets, monitoring different principals, monitoring different data fields, storing different data, and the like. For example, in an embodiment a first cybersecurity monitoring system is configured to store a unique identifier of a resource under an “ID” data field, whereas a second cybersecurity monitoring system is configured to store a unique identifier of the same resource as “Name”. Respective of a unification environment, each cybersecurity monitoring system is a source of the computing environment 110. Those skilled in the art will appreciate the present disclosure uses the two cybersecurity monitoring systems 121, 122 for illustration purposes—practical embodiments may include more than two systems, which is contemplated with the techniques described herein.

It is therefore beneficial to utilize a single data structure to store data from multiple sources. In some embodiments, the data structure includes a metadata indicator to indicate an identifier of the source for a certain data field. In some embodiments, the data structure includes a metadata indicator to indicate that a data field value is cross-referenced between a plurality of sources. A metadata indicator is configured to receive a value, according to an embodiment, which corresponds to a predetermined status. In an embodiment, the resource 114 is represented by a resource node 210. The resource 114 is, for example, a physical machine, a virtual machine, a software container, a serverless function, a software application, a platform as a service, a software as a service, an infrastructure as a service, and the like. In an embodiment, the resource node 210 includes a data structure which is selected for the resource node 210 based on a resource type indicator. For example, in an embodiment a first resource is a virtual machine for which the resource node 210 is stored based on a first resource type, and a second resource is an application for which a resource node is stored based on a second resource type.

The resource node 210 is connected (e.g., via a vertex) to a principal node 220, an operating system (OS) node 212, an application node 214, and a certificate node 216. In an embodiment, a vertex further indicates a relationship between the represented nodes. For example, a vertex connecting a resource node 210 to a principal node 220 indicates, according to an embodiment, that the principal represented by the principal node 220 can access the resource represented by the resource node 210. In an embodiment, the principal node 220 represents a principal, such as a user account, a service account, a role, and the like.

In an embodiment, the first cybersecurity monitoring system 121 detects a resource in the computing environment 110, and scans the resource 114 to detect an operating system (OS). The resource 114 is represented by the resource node 210, the operating system is represented by the OS node 212, and a vertex is generated between the resource node 210 and the OS node 212 to indicate that the OS is deployed on the resource 114. The second cybersecurity monitoring system 122 detects the resource 114 in the computing environment 110, and further detects an application executed on the OS of the resource 114. The application is represented in the graph by the application node 214, and connected to the resource node 212. As the first cybersecurity monitoring system 121 already detected the resource 114, there is no need to duplicate the data and generate another representation of the resource 114 based on the second cybersecurity monitoring system 122. Instead, any data differences are stored in the resource node 210 representing the resource 114.

In some embodiments, the first cybersecurity monitoring system 121 is further configured to scan the contents of a disk of the resource 114, and detect cybersecurity objects, such as an encryption key, a cloud key, a certificate, a file, a folder, an executable code, a malware, a vulnerability, a misconfiguration, an exposure, and the like. For example, in an embodiment, the second cybersecurity monitoring system 122 is further configured to scan the resource and detect a certificate, represented by certificate node 216. In an embodiment, a source for the unification environment 130 is an identity and access management (IAM) service. In some embodiments, an IAM service includes a rule, a policy, and the like, which specify an action a principal is allowed to initiate, an action which a principal is not allowed to initiate, combinations thereof, and the like. Of course, the source for the unification environment 130 can be any type of cybersecurity monitoring system.

In some embodiments, an IAM service is queried to detect an identifier of the principal 112. The principal 112 is represented in the graph by a principal node 220, and is, according to an embodiment, a user account, a service account, a role, and the like. In an embodiment, the IAM service is further queried to detect an identifier of a key, an identifier of a policy, and the like, which are associated with the principal 112. For example, in an embodiment, a cloud key which is assigned to the principal 112 represented by the principal node 220, is represented by a cloud key node 222. In an embodiment, the cloud key represented by the cloud key node 222 allows the principal represented by the principal node 220 to access the resource represented by the resource node 210.

In some embodiments, the resource 113 is represented by a plurality of resource nodes 210, each resource node 210 corresponding to a unique data source. In such embodiments, it is useful to generate an uber node which is connected to each node which represents the resource. In an embodiment, generating an uber (i.e., over, above, etc.) node and storing the uber node in the graph allows to generate a compact view of assets of the computing environment 110, while allowing traceability of the data to each source. An example embodiment of such a representation is discussed in more detail with respect to FIG. 3 below.

FIG. 3 illustrates an example schematic illustration of an uber node 320 of a representation graph, implemented according to an embodiment. In an embodiment, the mapper 134 is configured to receive data from multiple sources, detect an entity represented by a plurality of sources, and map data fields from each source to a data field of an uber node 320 which represents the entity in a graph data structure. For example, a first entity 310 is represented by a first source using a first data schema, and a second entity 330 is represented by a second source using a second data schema, in an embodiment. In certain embodiments, the first source is, for example, a SaaS solution provided by Servicenow®, and the second source is, for example, a SaaS solution provided by Rapid7. Each source interacts with a computing environment, the resources therein, the principals therein, and the like, in a different manner, using different methods, and store data utilizing different data structures, in accordance with an embodiment. That is, data from the different cybersecurity monitoring systems 121, 122 is mapped to the graph.

In an embodiment, the first entity 310 includes a first plurality of data fields, such as ‘name’, ‘MAC address’ (media access control), ‘IP address’, and ‘OS’. In some embodiments, the second entity 330 includes a second plurality of data fields, such as ‘ID’, ‘IP’, ‘OS’, and ‘Application’. In certain embodiments, the mapper 134 is configured to detect values of data fields which match the first entity 310 to the second entity 330. In some embodiments, the mapper 134 is further configured to map the data fields of each of the sources to a data field of an uber node 320, which is a representation of an entity based on a plurality of different sources.

For example, in an embodiment the data field ‘Name’ of the first entity 310, and the data field ‘ID’ of the second entity 330, are mapped to the data field ‘Name’ of the uber node 320. In some embodiments, the mapper 134 is configured to utilize a rule engine to match a first entity to a second entity and generate therefrom an uber node 320. For example, in an embodiment, a first entity 310 is matched to a second entity 330 based on a rule stipulating that a value of the data field ‘Name’ from a first source should match a value of the data field ‘ID’ of a second source. In some embodiments, a plurality of values from a first source are matched to a plurality of values from a second source, in determining that a first entity matches a second entity. For example, in an embodiment a plurality of values correspond to a unique identifier (e.g., ‘name’, ‘ID’, and the like) coupled with an IP address.

### Method for Generating a Unified Cybersecurity Object

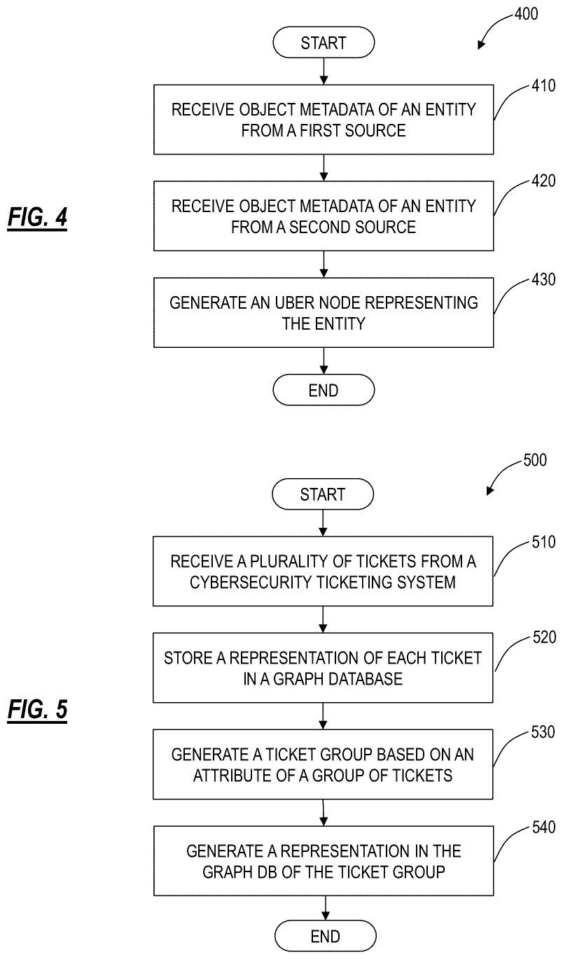

FIG. 4 illustrates an example flowchart of a method 400 for generating a unified cybersecurity object, implemented according to an embodiment. The method 400 contemplates implementation as a computer-implemented method to perform steps, via a processing device configured to implement the steps, via a cloud service configured to implement the steps, via the unification environment 130 configured to implement the steps, and via a non-transitory computer-readable medium storing instructions that, when executed, cause one or more processors to implement the steps.

Metadata is received from a first source (step 410). In an embodiment, the metadata describes a data structure of a first entity of the computing environment 110. For example, in an embodiment, the metadata includes data fields, data descriptors, data indicators, and the like. In some embodiments, data is further received from the first source. In an embodiment, data includes a representation of entities in the computing environment 110, a data record of an event, action, and the like which occurred in the computing environment 110, event information from an IAM service, and the like. In some embodiments, a source is an IAM service, a SaaS connected to the computing environment, a platform-as-a-service (PaaS) connected to the computing environment, an infrastructure-as-a-service (IaaS) connected to the computing environment, a cybersecurity monitoring system, a ticketing system, a data lake, a business intelligence (BI) system, a customer relationship management (CRM) software, an electronic management system (EMS), a warehouse management system, and the like. According to an embodiment, a source is a cloud computing environment, which interacts with, monitors, and the like, the computing environment 110 in which the first entity is deployed.

In an embodiment, the first entity is a cloud entity, a resource, a principal 112, an enrichment, an event, a cybersecurity threat, and the like. For example, in an embodiment, the resource 114 is a virtual machine, a software container, a serverless function, an application, an appliance, an operating system, and the like. In some embodiments, the principal 112 is a user account, a service account, a role, and the like. In an embodiment, an enrichment is data which is generated based on applying a predefined rule to data gathered from the computing environment.

Metadata is received from a second source (step 420). In an embodiment, the metadata describes a data structure of a second entity of the computing environment 110 from a second source, which is not the first source. For example, in an embodiment, the metadata includes data fields, data descriptors, data indicators, and the like. In some embodiments, data is further received from the first source. In an embodiment, data includes a representation of entities in the computing environment 110, a data record of an event, action, and the like which occurred in the computing environment 110, event information from an IAM service, and the like. Again, a source is an IAM service, a SaaS connected to the computing environment, a PaaS connected to the computing environment, an IaaS connected to the computing environment, a cybersecurity monitoring system, a ticketing system, a data lake, a business intelligence (BI) system, a customer relationship management (CRM) software, an electronic management system (EMS), a warehouse management system, and the like. In an embodiment, the first source and the second source are different sources of the same type. For example, AWS Identity and Access Management and Okta® provide two solutions (i.e., sources) of the same type (i.e., identity and access management services) from different sources. Alternatively, the first source and the second source are different sources of different types.

In an embodiment, the second entity is a cloud entity, a resource, a principal 112, an enrichment, an event, a cybersecurity threat, and the like. For example, in an embodiment, a resource 114 is a virtual machine, a software container, a serverless function, an application, an appliance, an operating system, and the like. In some embodiments, a principal 112 is a user account, a service account, a role, and the like. In an embodiment, an enrichment is data which is generated based on applying a predefined rule to data gathered from the computing environment.

An uber node is generated (step 430). In an embodiment, an uber node is generated based on a predefined data structure to represent the entity. In some embodiments, the predefined data structure is a dynamic data structure. In an embodiment, a dynamic data structure includes an initial data structure which is adaptable based on data fields received from various sources. For example, in an embodiment, a data field is detected from a first source which is not mappable to an existing data field in the predefined data structure. In such an embodiment, the detected data field is added to the predefined data structure, and the value of the detected data field is stored based on the adapted predefined data structure.

In certain embodiments, the uber node is generated based on a determination that the first entity from the first source and the second entity from the second source are a single entity on which data is received from both the first source and the second source. For example, in an embodiment a match is performed between a predefined data field, a plurality of predefined data fields, and the like, to determine, for example by generating a comparison, if a value of a data field of the first entity matches a value of a corresponding data field of the second entity (e.g., same IP address, same MAC address, same unique identifier, etc.).

In some embodiments, the uber node is generated in a graph which further includes a representation of the computing environment 110, a representation of the first source, a representation of the second source, combinations thereof, and the like. In certain embodiments, a first node is generated in the graph to represent the first entity, and a second node is generated in the graph to represent the second entity. According to an embodiment, a connection is generated between each of the first node and the second node with the uber node. In an embodiment, the uber node represents a cloud entity, such as a principal 112, a resource 114, an enrichment, and the like. In some embodiments, the uber node represents a cybersecurity object, such as a cybersecurity threat (e.g., a malware code, a malware object, a misconfiguration, a vulnerability, an exposure, and the like), a cloud key, a certificate, and the like. In certain embodiments, the uber node represents a ticket, for example generated from a Jira® ticketing system.

The method 400 describes a process for generating a unified cybersecurity object—an “uber node”—from diverse data sources within a computing environment. This process enables a holistic view of entities (like virtual machines, user accounts, applications, and cybersecurity threats) from various systems, such as IAM services, software as a service (SaaS), or cybersecurity monitoring systems. First, metadata and data representing entities are received from a primary source, which might include data on events, actions, or configurations relevant to the computing environment. This metadata describes structures like data fields, descriptors, and indicators. Next, similar information is collected from a secondary source that differs from the first, possibly representing the same type (such as two IAM services) or different types (like an IAM service and a CRM platform).

An uber node is then created based on a flexible data structure, which adapts to incorporate unique data fields from these sources. This uber node consolidates data by matching fields from both sources—like IP addresses or unique identifiers—to confirm they refer to the same entity. In some cases, the uber node is created within a graph, connecting representations of the sources and their respective data. Ultimately, this unified cybersecurity object can represent various items such as threats, vulnerabilities, cloud keys, or tickets, enabling an interconnected, detailed view that supports effective threat detection and analysis across an organization's digital environment. This method provides a robust, scalable approach to centralizing cybersecurity insights from disparate data sources, making it easier to track and respond to security threats in real-time

### Method for Representing Tickets of a Cybersecurity Ticketing System

FIG. 5 illustrates an example flowchart of a method 500 for representing tickets of a cybersecurity ticketing system, implemented according to an embodiment. The method 500 contemplates implementation as a computer-implemented method to perform steps, via a processing device configured to implement the steps, via a cloud service configured to implement the steps, via the unification environment 130 configured to implement the steps, and via a non-transitory computer-readable medium storing instructions that, when executed, cause one or more processors to implement the steps.

The cybersecurity ticketing system is a ticketing system which generates tickets based on alerts received from the cybersecurity monitoring systems 121, 122. The cybersecurity ticketing system is a centralized platform for managing and tracking security incidents, vulnerabilities, and related tasks within an organization. When a security event occurs, such as a potential breach, malware detection, or policy violation, the system generates a “ticket” that records critical details about the incident, including the nature of the threat, affected systems, and recommended actions. These tickets are then assigned to the relevant cybersecurity team members, who investigate, respond, and resolve the issues according to priority levels. The ticketing system allows for consistent documentation, helps prioritize threats, and ensures timely follow-ups and accountability. Additionally, it provides insights and reporting capabilities, helping organizations improve their security posture by identifying recurring vulnerabilities and streamlining response workflows.

A plurality of tickets are received (step 510). In an embodiment, each ticket of the plurality of tickets is generated based on an alert from a cybersecurity monitoring system. 121, 122 In some embodiments, a ticket is generated based on a unique alert. In certain embodiments a ticket is generated based on a plurality of unique alerts. In some embodiments, a plurality of tickets are generated based on a single alert. In an embodiment, an alert includes an identifier of a cybersecurity issue, an identifier of a resource 114 on which the cybersecurity issue was detected, a timestamp, an identifier of a computing environment in which the resource 114 is deployed, a combination thereof, and the like.

In certain embodiments, a ticket generated based on an alert includes an identifier of a cybersecurity issue, an identifier of a resource on which the cybersecurity issue was detected, a timestamp, an identifier of a computing environment 110 in which the resource 114 is deployed, a ticket status indicator, a combination thereof, and the like. In an embodiment, a ticket status indicator includes a value, such as open, resolved, closed, and the like.

A representation of each ticket of the plurality of tickets is stored in a graph database (step 520). In certain embodiments, storing a ticket in a graph database includes generating a node in the graph which represents the ticket. In an embodiment, the representation for each ticket is a node in the graph, as described herein. In certain embodiments, storing the representation (i.e., node) in the graph includes storing ticket data associated with the node. For example, ticket data such as a view indicator, an identifier of a cybersecurity issue, an identifier of a resource on which the cybersecurity issue was detected, a timestamp, an identifier of a computing environment in which the resource is deployed, a ticket status indicator, a combination thereof, and the like, is stored in the graph database.

A ticket group is generated based on a shared attribute of a group of tickets (step 530). In certain embodiments, a ticket group is generated based on clustering techniques. A clustering technique is, according to an embodiment, a K-means clustering, DBSCAN clustering, Gaussian Mixture Model clustering, BIRCH clustering, spectral clustering, and the like, to enable organization of tickets into clusters based on similarities in attributes such as category, severity, source, or timestamp. For instance, K-means clustering partitions tickets into a predetermined number of clusters based on their distance in feature space, providing a straightforward way to group similar tickets. DBSCAN, on the other hand, detects clusters of arbitrary shapes and isolates noise, making it ideal for identifying outliers, such as sporadic security incidents. Gaussian Mixture Models allow for probabilistic clustering, capturing complex ticket distributions where each ticket may have partial association with multiple clusters. BIRCH clustering leverages a hierarchical structure for scalable clustering, especially effective in high-dimensional datasets common in enterprise environments. Spectral clustering, which uses eigenvalues of similarity matrices, can identify clusters in non-convex spaces, making it suitable for discovering intricate ticket relationships. By applying these clustering techniques, the system intelligently groups tickets to form meaningful clusters, enhancing the efficiency of incident tracking, prioritization, and response within cybersecurity and IT service environments.

In an embodiment a plurality of values of an attribute are extracted from a plurality of tickets. In certain embodiments, tickets are clustered based on the extracted plurality of values. In some embodiments, a threshold is used to determine if a value of an attribute of a ticket should be clustered into a first group, a second group, and the like. For example, in an embodiment, software versions having a value between ‘1.1’ and ‘2.3’ are clustered into a first group, software versions having a value between ‘2.4’ and ‘3.2’ are clustered into a second group, etc.

In some embodiments, a ticket group is generated by applying a rule from a rule engine on a plurality of tickets. In an embodiment, a ticket group represents a group of tickets, having at least one attribute value in common. An attribute is, in an embodiment, a type of resource, an identifier of a cybersecurity issue, an identifier of an application, and the like. For example, a value of a type of resource is a virtual machine, a software container, a serverless function, and the like. A value of an attribute such as an identifier of a cybersecurity issue is, for example, a unique Common Vulnerabilities and Exposure (CVE) identifier. In an embodiment, a shared attribute is an application vulnerability of a specific application. For example, the application is Google® Chrome® web browser having any vulnerability. As another example, the shared attribute is a node of a repository, such as GitHub®. When used to group tickets, this attribute groups all tickets representing a vulnerability originating directly from the node of the repository, originating from a library to which the node has a dependency of, and the like.

A representation of the ticket group is generated in the graph database (step 540). In an embodiment, the representation for the ticket group is a group node in the graph, the group node connected to a plurality of nodes, each representing a unique ticket which comprises the ticket group. In certain embodiments, storing the representation (i.e., node) in the graph includes storing ticket data associated with the node. For example, ticket data such as a view indicator, an identifier of a cybersecurity issue, an identifier of a resource on which the cybersecurity issue was detected, a timestamp, an identifier of a computing environment in which the resource is deployed, a ticket status indicator, a combination thereof, and the like, is stored in the graph database.

In an embodiment, a view indicator receives a numerical value. For example, in an embodiment a base view (i.e., a view having the least number of tickets) includes all tickets, ticket groups, and the like, having a view value of ‘0’. For example, ticket group nodes, and ticket nodes not connected to a ticket group node, receive a view value of ‘0’ in an embodiment. Ticket nodes which are connected to a ticket group node receive a value of ‘1’. Where a request is received to generate a view on a display with a view value of ‘1’ or lower, are visually represented on the display.

The method 500 describes representing and managing cybersecurity tickets, enhancing tracking and response to security incidents within an organization. This process begins by generating tickets based on alerts from cybersecurity monitoring systems. Each ticket logs crucial details—such as the cybersecurity issue identifier, resource affected, timestamp, and ticket status—that help the cybersecurity team investigate and resolve incidents. These tickets are stored in a graph database, with each ticket represented as a unique node. By structuring data this way, the system can efficiently manage complex relationships and easily retrieve ticket information. Next, tickets sharing specific attributes are grouped, leveraging clustering algorithms like K-means, DBSCAN, Gaussian Mixture Models, BIRCH, and spectral clustering to find patterns and similarities among tickets. For instance, tickets may be grouped by severity, source, or timestamp, with clustering helping to identify trends and outliers, such as repeated incidents or one-off security threats. Clustering can also be threshold-based, grouping tickets by attribute ranges (e.g., software versions).

Beyond clustering, ticket groups can also be formed using rule-based engines that apply predefined rules on ticket attributes, like CVE identifiers or specific applications. This rule-based approach allows the system to group tickets by shared characteristics, such as vulnerabilities in a specific application (e.g., Google Chrome) or a repository node in GitHub, enabling comprehensive tracking of related vulnerabilities across resources. Finally, the grouped tickets are represented in the graph database as “group nodes” connected to individual ticket nodes, allowing easy visualization of relationships. The system can use a “view indicator” to control visibility of ticket nodes, where a view level indicates which tickets or groups are displayed. This view-based representation streamlines the workflow, allowing cybersecurity teams to focus on high-priority incidents, identify recurring vulnerabilities, and efficiently coordinate responses across the organization's digital landscape.

### Method for Maintaining Digital Asset Status

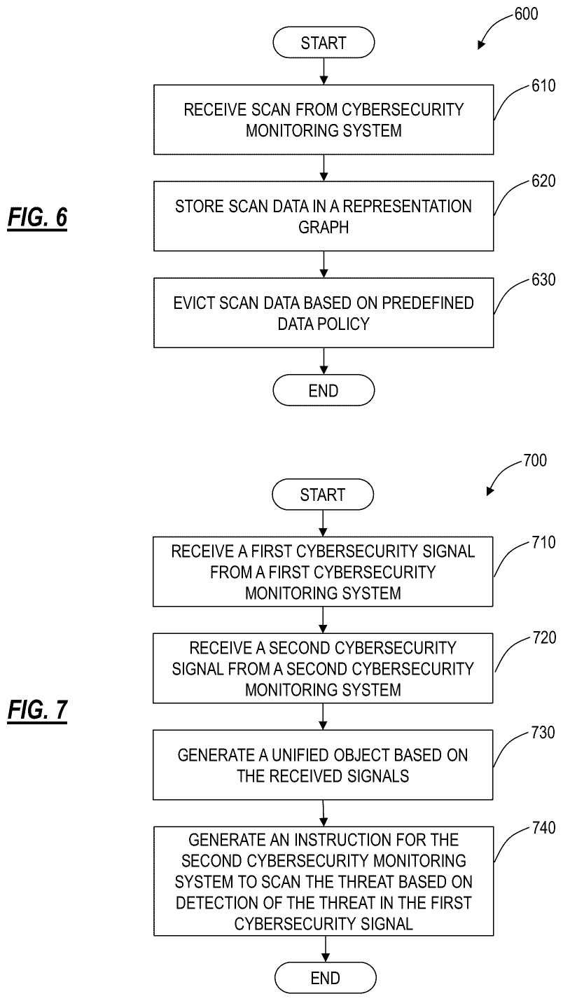

FIG. 6 illustrates an example flowchart of a method 600 for maintaining digital asset status, implemented according to an embodiment. The method 600 contemplates implementation as a computer-implemented method to perform steps, via a processing device configured to implement the steps, via a cloud service configured to implement the steps, via the unification environment 130 configured to implement the steps, and via a non-transitory computer-readable medium storing instructions that, when executed, cause one or more processors to implement the steps.

A scan is received from a cybersecurity monitoring system 121, 122 (step 610). In an embodiment, the scan includes data generated from a first cybersecurity monitoring system 121 at a first time, data generated from a second cybersecurity monitoring system 122 at the first or different time, a combination thereof and the like. In an embodiment, a scan includes an identifiers of a resource 114, an identifier of a principal 112, a risk detected on a resource 114, a risk associated with a principal 112, an identifier of a ticket, a combination thereof, and the like.

In some embodiments, a scan is received as a full scan, an incremental scan, a partial scan, a combination thereof, and the like. For example, in an embodiment, a combination of a scan includes a full scan received from a first cybersecurity monitoring system 121 at a first time, a partial scan received from a second cybersecurity monitoring system at the first time 122, etc. In an embodiment, a full scan maintains a consistent state of all principals 112, resources 114, vulnerabilities, misconfigurations, exposures, tickets, and the like, that exist in the computing environment. In certain embodiments, an incremental scan is provided by a cybersecurity monitoring system 121, 122 which maintains a full list of all entities in the computing environment 110, and further includes a log having a record corresponding to each change that occurred over time, allowing to retrieve changed entities after a specific point in time. In an embodiment, a partial scan includes information about entities encountered on the last scan. Therefore, if a resource 114 was unreachable at the last scan, for example, this specific resource 114 will not exist in the data we retrieved from the scanner. This does not mean necessarily that a cybersecurity issue was resolved. It is therefore beneficial to maintain a state from a partial scan over time, which allows to determine for various entities what their state is.

The scan data is stored in a representation graph (step 620). In an embodiment, the scan data is stored for a predetermined amount of time. For example, in an embodiment, a first scan data received at a first time includes an identifier of a resource 114 having a cybersecurity threat. According to an embodiment, a second scan data received at a second time does not include the identifier of the resource 114. In some embodiments, the identifier of the resource 114 having the cybersecurity threat is stored for a predefined period of time, for a predefined number of received scans, a combination thereof, and the like.

Scan data is evicted (step 630). In an embodiment, scan data is evicted based on an eviction policy. In some embodiments, the eviction policy includes a condition whereby a full scan indicates that a ticket is resolved, a cybersecurity threat is mitigated, and the like. For example, in an embodiment, a plurality of scan data are received, each at a different time. In an embodiment, where the plurality of scan data exceeds a predefined threshold (e.g., four times scan data is received from the same cybersecurity monitoring system 121, 122), the identifier of the resource having the cybersecurity threat is deleted, removed, and the like, from the representation graph.

In an embodiment, a first scan data is received at a first time indicating that a first resource includes a cybersecurity threat. The scan data is stored in the representation graph, according to an embodiment. For example, in an embodiment, the first resource 114, the cybersecurity threat, and the like, are represented in the representation graph. In an embodiment, a second scan data is received at a second time, indicating that the first resource does not include the cybersecurity threat. In certain embodiments, the representation of the cybersecurity threat is evicted (e.g., deleted, removed, etc.) from the representation graph in response to detecting that the cybersecurity threat is not detected in the second scan data. In some embodiments, the second scan data and the first scan data are each a full scan.

The method 600 outlines tracking and maintaining the status of digital assets, such as resources and principals, within a cybersecurity monitoring environment. This process begins with receiving scans from one or more cybersecurity monitoring systems, each scan containing data that may include identifiers for resources, principals, detected risks, and associated tickets. Scans can be comprehensive (full scans), capturing a complete snapshot of the environment, incremental, showing only changes since the last full scan, or partial, covering only certain entities. For instance, a full scan provides a consistent state of all resources, vulnerabilities, and tickets, while an incremental scan logs recent changes, and a partial scan covers only reachable entities, which might exclude unreachable assets without indicating resolved issues.

The scan data is then stored in a representation graph, where each entry is retained for a set period or number of scans, allowing cybersecurity teams to track the presence or absence of threats over time. This approach enables the system to detect recurring issues, even if an entity is not included in every scan. An eviction policy controls the removal of outdated or resolved scan data. For instance, if a full scan indicates that a threat has been mitigated or a ticket resolved, the relevant data can be removed from the graph. This mechanism ensures that only current and relevant information is retained, reducing data clutter and streamlining analysis. By storing and dynamically updating threat data in a graph structure, the system provides a comprehensive and timely view of an organization's cybersecurity posture, allowing security teams to respond effectively to vulnerabilities and maintain an up-to-date understanding of their digital assets.

Method for Initiating Monitoring of a Computing Environment Based on a Scan Result from Another Monitoring System

FIG. 7 illustrates an example flowchart of a method 700 for initiating monitoring of a computing environment based on a scan result from another monitoring system, implemented according to an embodiment. The method 700 contemplates implementation as a computer-implemented method to perform steps, via a processing device configured to implement the steps, via a cloud service configured to implement the steps, via the unification environment 130 configured to implement the steps, and via a non-transitory computer-readable medium storing instructions that, when executed, cause one or more processors to implement the steps.

A first cybersecurity signal is received (step 710). In an embodiment, the first cybersecurity signal is received from a first cybersecurity monitoring system 121, configured to monitor a computing environment 110 for a cybersecurity threat. For example, in an embodiment, the cybersecurity threat is detected based on a cybersecurity object. A cybersecurity object is, according to an embodiment, a secret, a certificate, a misconfiguration, user account data, and the like. In an embodiment, the first cybersecurity signal includes scan data from a scanner of the first cybersecurity monitoring system 121.

A second cybersecurity signal is received (step 720). In an embodiment, the second cybersecurity signal is received from a second monitoring system 122, configured to monitor the computing environment 110 for a cybersecurity threat. In certain embodiments, the second monitoring system 122 is independent of the first monitoring system 121. In certain embodiments, scan data of the second cybersecurity signal includes a cybersecurity object, a cybersecurity threat, and the like, which are not detected in corresponding scan data of the first cybersecurity signal. This can be, for example, due to differences in scanning capabilities between two cybersecurity monitoring systems, differences in access times, differences in access capabilities, and the like. For example, in an embodiment, the first cybersecurity monitoring system 121 detects a cybersecurity threat on a resource at a first time, while the second cybersecurity monitoring system 122 does not detect the cybersecurity threat on the resource at the first time.

A unified cybersecurity object is generated (step 730). In an embodiment, the unified cybersecurity object is generated based on the first cybersecurity signal and the second cybersecurity signal. An example of generating a unified cybersecurity object is discussed in more detail with respect to FIG. 4 above. An advantage of having a unified cybersecurity object is having a complete picture of all entities, risks, threats, tickets, and the like, associated with the computing environment 110.

An instruction is generated to scan for the cybersecurity threat (step 740). In an embodiment, the cybersecurity threat is detected in the first signal, and not detected in the second signal. In such an embodiment, an instruction is generated which when executed by the second cybersecurity monitoring system 122, configures the second cybersecurity monitoring system to initiate a scan of the resource, the computing environment 110, a combination thereof, and the like, for the cybersecurity threat detected by the first cybersecurity monitoring system 121.

The method 700 describes a process for coordinating monitoring across multiple cybersecurity systems to ensure comprehensive coverage of a computing environment. The process begins by receiving an initial cybersecurity signal from a first monitoring system, which might identify a potential threat based on specific cybersecurity objects like secrets, certificates, or misconfigurations. This initial signal includes scan data highlighting identified vulnerabilities or risks. Soon after, a second cybersecurity signal is received from a separate monitoring system, which independently scans the same environment but may not identify the same threats. Variances in scan results can stem from differences in capabilities, access permissions, or scanning times between the systems, causing one system to detect certain threats that the other may miss.

To address this discrepancy, a unified cybersecurity object is generated, consolidating the data from both monitoring systems. This unified object serves as a central record that aggregates entities, risks, threats, and related tickets, providing a comprehensive view of the computing environment's security status. By synthesizing data from multiple sources, the unified object helps ensure no vulnerabilities are overlooked. Finally, an instruction is created to prompt the second monitoring system to rescan for the threat detected by the first system. This instruction directs the second system to focus on the specific resource or environment flagged in the initial scan, effectively synchronizing both monitoring systems to investigate the potential vulnerability further. This coordinated approach strengthens the organization's cybersecurity posture, leveraging multiple monitoring systems' unique strengths for a thorough, unified assessment of the computing environment's security.

### Why is it Difficult to Understand Risk Posture?

Enterprises today rely on a multitude of security tools to protect their digital environments, yet many security leaders still struggle with foundational questions that these tools ought to answer. Despite deploying endpoint detection and response (EDR) tools, for instance, there's often no clear assurance that every device is protected. Leaders seek insights into high-priority applications and a reliable count of assets, but asking three different tools might yield three different answers. More critically, executives want to understand the organization's risk posture and how it changes over time, but gathering and tracking that information remains challenging.

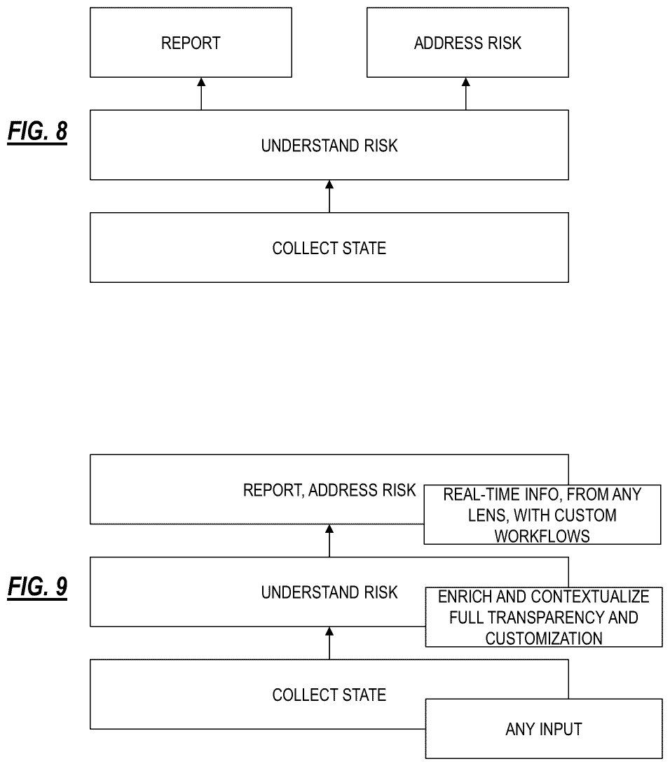

This complexity arises because each tool operates independently within its specific domain—whether endpoint protection, identity management, or cloud security. Each tool collects data, analyzes risks within its narrow focus, and then provides reports and remediation options, as illustrated in FIG. 8. However, this process repeats across dozens of tools, each with its own metrics, definitions, and action plans. Furthermore, each tool's approach is shaped by the vendor's perspective, defining which metrics are important, how risk is measured, and what actions can be taken.

The result is a fragmented view of risk, with data siloed in each tool and insights locked within opaque, vendor-defined processes that offer limited flexibility for organizations to adapt or customize. Without centralized oversight and customizable intelligence, security leaders are left with a patchwork understanding of risk, unable to effectively track or control their overall security posture. This lack of integration and transparency makes it nearly impossible to see and manage risk comprehensively, leaving many organizations unsure of their true security standing.

### A Transformative Approach to Risk Management

The present disclosure provides a transformative approach to risk management by consolidating security data from various tools (cybersecurity monitoring systems 121, 122) into a unified platform (unification environment 130) that enables comprehensive, context-rich insights. Instead of relying on isolated security tools that offer limited views, the unified platform gathers data from across the entire security landscape, creating a single, holistic repository for all types of security information. This data, which includes traditional vulnerability feeds as well as threat intelligence, cloud configurations, and user behavior insights, is processed within the unified platform to construct a dynamic “security knowledge graph.” This graph enables real-time enrichment, correlation, and de-duplication of information, connecting disparate data points to reveal hidden relationships and contextualize risk more effectively. FIG. 9 illustrates a flowchart of this transformative approach to risk management by consolidating security data.

This framework goes beyond basic vulnerability management by offering transparent, customizable insights into risk. This means users can see exactly how risk is calculated, adjust metrics as needed, and automate workflows tailored to their organization's processes. The reports and dashboards are not only customizable but also equipped with out-of-the-box configurations to support immediate use, allowing organizations to view and mitigate risk from various perspectives—whether by asset, user, application, or specific vulnerability. By continuously updating and contextualizing the data, this provides security teams with a live, detailed view of their security posture, making it easier to understand, report on, and respond to risks dynamically. This integrated approach provides a much richer dataset for vulnerability management and ensures that security actions are aligned with real-world conditions, enhancing an organization's ability to maintain a resilient risk posture.

### Data Fabric

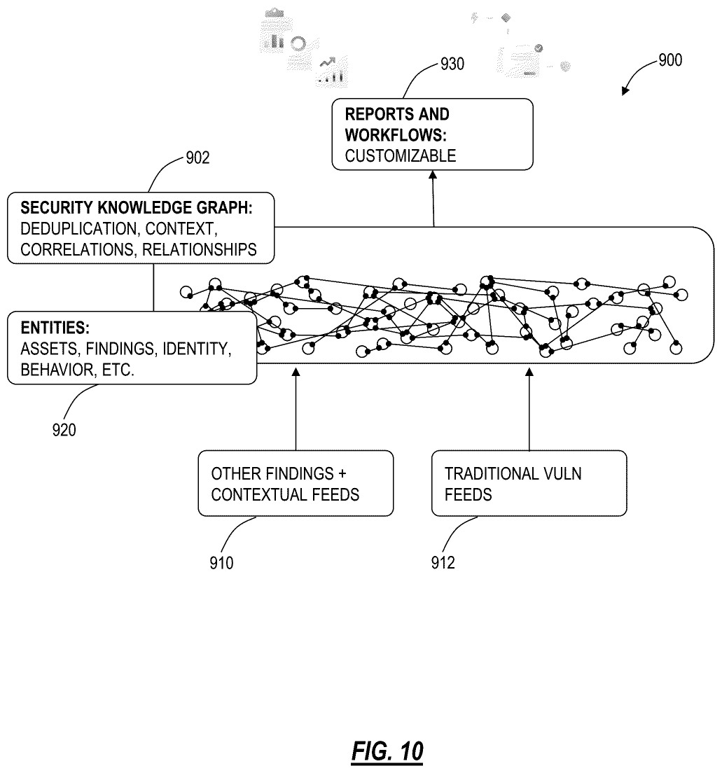

FIG. 10 illustrates a functional diagram of a data fabric 900 implemented using a security knowledge graph 902 based on the various techniques described herein. The data fabric 900 can be implemented in the unification environment 130, such as in a cloud computing environment. The data fabric 900 provides a transformative, unified framework for managing security data and analyzing risk across an organization's computing environment 110. The data fabric 900 consolidates diverse data sources 910, 912—including vulnerability feeds, threat intelligence, endpoint telemetry, user behavior analytics, and cloud configuration details—into a centralized security knowledge graph 902. At the core is the security knowledge graph 902, which ingests data from each security tool (cybersecurity monitoring system 121, 122), normalizes and deduplicates it, and establishes comprehensive relationships between entities 920 such as users, devices, applications, and vulnerabilities, e.g., the resources 114 and the principals 112.

To build the security knowledge graph 902, each data feed 912, 912 is parsed and standardized, transforming disparate information into a structured format, such as described herein. Unique identifiers, like IP addresses or user IDs, are used to match and merge duplicate entries, ensuring a consistent, de-duplicated view of each entity 920 across the computing environment 110. As the graph 902 forms, it enriches each node by connecting it to related entities 920—for instance, linking a user account to associated devices, logged activities, and access privileges, or associating a vulnerability with impacted assets and connected permissions. This enriched, interconnected data model allows the security knowledge graph 902 to reveal hidden dependencies and risk pathways within the organization.

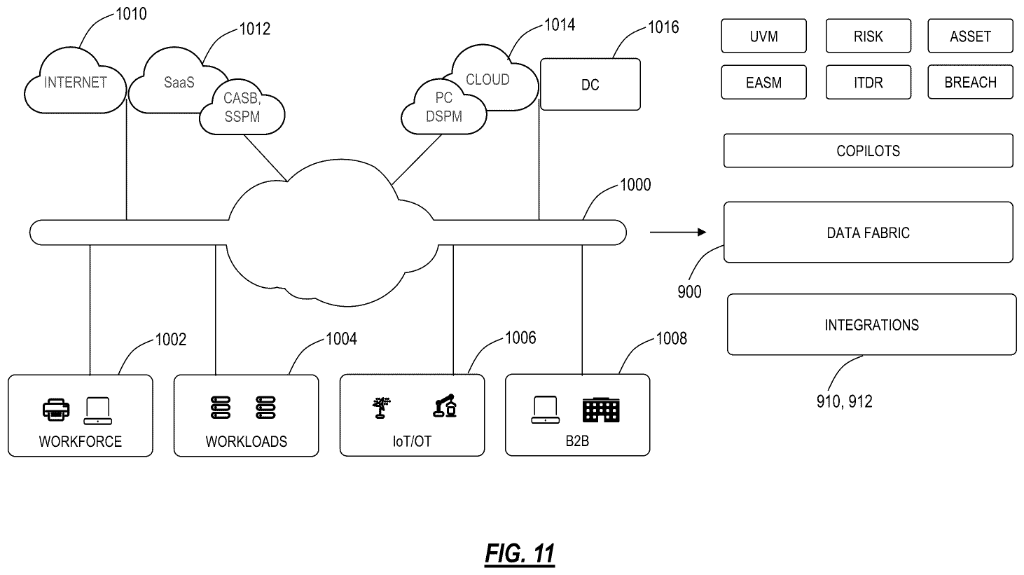

Once established, the security knowledge graph 902 supports in-depth, real-time threat analysis. By applying graph-based algorithms, such as path analysis and clustering, the unification environment 130 can trace risk pathways, enabling security teams to investigate how a detected vulnerability might be exploited across linked entities. Machine learning models are layered on top to detect anomalies, such as unexpected access patterns or high-risk behavior, that may indicate a potential threat. It is also possible to integrate various cloud services (see FIG. 11) within the data fabric 900 further enhancing visibility, especially within cloud and hybrid environments, providing insights into user access, network traffic, and application security in real-time.

The data fabric 900 also enables transparent, adaptable security management. Security teams can customize risk calculations and metrics, aligning them with organizational priorities and adjusting them as security needs evolve. Reports and automated workflows 930 mirror actual organizational processes, helping teams prioritize and respond to threats more effectively. Additionally, the data fabric 900 offers both out-of-the-box and customizable dashboards, transforming data into actionable intelligence with a live, holistic view of the security landscape. This approach equips security leaders with the tools to monitor, assess, and dynamically manage security posture, fostering a proactive and resilient cybersecurity strategy in today's complex, multi-tool environments.

### AI to Analyze the Security Knowledge Graph

Artificial intelligence (AI) enhances the analysis of the security knowledge graph 902 by applying machine learning (ML) algorithms and advanced data analytics to uncover insights, detect threats, and automate responses. In this graph-based model, AI techniques are used to process and interpret vast, interconnected security data, enabling proactive threat detection and response through the following methods:
(1) Anomaly Detection: AI models, particularly unsupervised learning techniques, are used to detect unusual patterns within the graph 902. By analyzing normal behavior across nodes (e.g., typical user activity, network traffic, or access patterns), AI can spot deviations that could indicate insider threats, compromised accounts, or anomalous activities. This might include spotting unexpected data transfers, atypical login locations, or unusual access times.
(2) Pattern Recognition and Risk Scoring: Using graph-based pattern recognition, AI can identify known threat patterns—like lateral movement attempts, privilege escalation, or indicators of malware behavior. Supervised ML models, trained on past incidents, assign risk scores to entities within the graph 902 based on these patterns. The AI continuously updates these scores as new data is ingested, ensuring real-time assessment of risk across the computing environment 110.
(3) Correlation and Contextualization: AI-driven correlation algorithms enhance the graph 902 by linking seemingly unrelated data points based on learned relationships, uncovering hidden connections among threats, users, and assets. For instance, AI can correlate a vulnerability detected on a cloud resource with an unusual login attempt by a privileged user, flagging it as a potential vector for an attack. By contextualizing these connections, AI helps analysts prioritize threats based on their relevance and potential impact.
(4) Predictive Threat Intelligence: AI models trained on historical attack data, threat intelligence feeds, and cyber event patterns help predict likely attack paths or potential vulnerabilities. In the security knowledge graph 902, predictive AI identifies high-risk entities and can simulate potential attack scenarios by analyzing connected nodes, helping security teams preemptively address weak points before they are exploited.
(5) Automated Insights and Workflow Triggers: AI can generate automated insights, providing suggested actions or automated workflows based on the analysis of the graph 902. For instance, if AI detects a critical vulnerability with a high likelihood of exploitation, it can trigger an automated workflow to isolate the affected resource, alert relevant personnel, and initiate further scanning of connected nodes. This automation streamlines response times and reduces manual intervention for recurring threats.
(6) Continuous Learning and Adaptation: AI models in the knowledge graph are designed to evolve as new data and attack techniques emerge. Using reinforcement learning, the AI adapts to feedback from analysts and integrates new threat intelligence, improving its ability to identify, contextualize, and respond to threats with increasing accuracy over time.

Through these techniques, AI transforms the security knowledge graph 902 from a static data repository into a dynamic, intelligent system. By automating pattern recognition, contextualizing threats, and enabling real-time risk assessment, AI empowers security teams to respond faster and more effectively, maintaining a stronger, more resilient security posture across the organization.

### Managing a Security Knowledge Graph

Managing a security knowledge graph involves a series of structured steps to integrate, normalize, update, and analyze data from multiple cybersecurity systems 121, 122, enabling a comprehensive and real-time view of the organization's security environment. Here's a step-by-step outline of the graph management process:
(1) Data Ingestion—Receive Data Feeds: The system collects data from various security tools and sources, such as vulnerability scanners, endpoint monitoring solutions, IAM systems, CASB platforms, threat intelligence feeds, and data storage assessments. Parse and Normalize Data: Each feed is parsed to extract relevant information and then normalized into a standard format. This ensures consistency when mapping data to nodes and vertices, regardless of the original data format.
(2) Node Creation and Updating—Identify Entities: The system examines each data feed to identify unique entities (e.g., users, devices, applications, vulnerabilities, data stores). Create New Nodes: If an entity does not already exist in the graph, a new node is created, with attributes such as IP addresses, OS versions, application names, data sensitivity levels, and so on. Update Existing Nodes: If the entity already exists, the system updates its attributes based on the latest information. For instance, if a vulnerability scanner detects a new patch on a device, the device node is updated with the latest software version.
(3) Relationship Mapping with Vertices—Establish Connections: The system generates vertices (edges) between nodes based on relationships detected in the data feeds. For example, an IAM feed may connect a user node to a device node the user has accessed. A vulnerability feed links a vulnerability node to the device nodes it affects. Add Context to Vertices: Each edge carries attributes, such as access permissions, data sensitivity, or time of access. This context is critical for understanding the nature and strength of each relationship, allowing for deeper analysis.
(4) Deduplication and Conflict Resolution—Identify Duplicate Nodes: Since different sources may report the same entities (e.g., a device's MAC address in both endpoint monitoring and CASB), the system checks for duplicate nodes using unique identifiers like MAC addresses, IPs, and usernames. Merge and Resolve Conflicts: Duplicate nodes are merged into a single entity. If there are conflicting attributes (e.g., different OS versions reported for a device), the system applies conflict resolution rules, often prioritizing the most recent or reliable source data.
(5) Contextual Enrichment and Correlation—Correlate Data Across Sources: The system enriches nodes and vertices by correlating data from multiple sources. For example, user behavior data from a CASB feed may be linked to vulnerabilities detected on devices frequently accessed by that user. Add Threat Intelligence: Real-time threat intelligence is integrated to enhance vulnerability nodes with new indicators or exploit methods, providing a deeper context for emerging risks.
(6) Real-Time Updates and Dynamic Adjustments—Continuous Monitoring: The graph management system monitors incoming data feeds, dynamically updating nodes and vertices as new information is ingested. For instance, if a device's security status changes (e.g., a new patch is applied), the corresponding node is immediately updated. Risk Scoring and Prioritization: As new data arrives, risk scores for assets, users, and vulnerabilities are recalculated based on updated configurations, user behavior, and external threat levels, allowing for prioritized focus on high-risk areas.
(7) Graph Analysis and Querying—Run Graph-Based Algorithms: The system leverages graph-based algorithms to analyze the structure, such as path analysis to detect potential attack vectors or clustering to identify high-risk groups of devices with shared vulnerabilities. Generate Insights: Automated queries and machine learning models generate insights, such as detecting anomalous access patterns or identifying relationships between vulnerabilities and high-value targets, which are flagged for immediate review.
(8) Workflow Automation and Alerts—Automated Actions: Based on predefined rules and risk thresholds, the system can trigger automated workflows, such as isolating a high-risk device, alerting the security team, or scheduling a patch for vulnerable software. Alerts and Notifications: When critical patterns or high-severity vulnerabilities are detected, alerts are sent to the relevant teams, ensuring timely awareness and response.
(9) Visualization and Reporting—Graph Visualization: The knowledge graph can be visualized to show the interconnected entities, relationships, and risk levels, helping analysts understand complex relationships at a glance. Generate Reports: Summary reports and dashboards provide detailed overviews of the current security posture, highlighting critical vulnerabilities, high-risk assets, and compliance with security policies.
(10) Feedback and Continuous Learning—Receive Analyst Feedback: Security analysts can provide feedback on false positives or emerging patterns, which the system uses to refine its algorithms and improve future risk assessments. Adapt to New Data Sources and Threats: As new tools or data sources are introduced, or as new threat vectors emerge, the graph management system adapts to incorporate these changes, continuously evolving to meet the organization's security needs.

By following these steps, the security knowledge graph 902 is managed as a dynamic, evolving structure that provides a comprehensive, up-to-date view of the organization's computing environment 110, supporting effective risk analysis, vulnerability management, and proactive threat response.

### Cloud-Based System

FIG. 11 illustrates a cloud-based system 1000 integrated with the data fabric 900. The cloud-based system 1000 can be the zero trust exchange (ZTE) platform available from Zscaler, Inc. The cloud-based system 1000 provides cloud services that secure and manage connectivity between diverse endpoints—including workforce devices 1002, workloads 1004, IoT (Internet of Things) and OT (Operational Technology) 1006, and business-to-business (B2B) connections 1008—and critical resources such as the Internet 1010, SaaS applications 1012, cloud services 1014, and data centers 1016. Unlike traditional network models, which rely on implicit trust within a perimeter, the cloud-based system 1000 adopts a zero-trust model, where each connection requires continuous identity verification and adherence to security policies.

Endpoints connect through the cloud-based system 1000 by routing their traffic through the cloud, where each request is authenticated, inspected, and authorized before being granted access to the target resource. For example, when an employee's device attempts to access a SaaS application 1012, the cloud-based system 1000 intercepts the traffic, verifies the user's identity and device posture, and enforces access policies based on user role, device security, and location. The cloud-based system 1000 uses encrypted tunnels to route all traffic securely, effectively isolating endpoints from the open Internet and preventing direct access to applications or data until identity and compliance checks are satisfied. This connection model ensures that only validated traffic reaches the intended destination, significantly reducing exposure to threats.

In addition to secure connectivity, the cloud-based system 1000 applies several layers of functionality to traffic passing through the platform. These include threat inspection, data loss prevention (DLP), and access control policies. Threat inspection involves scanning traffic for malware, phishing attempts, and other threats, utilizing advanced detection methods like sandboxing and behavior analysis. DLP policies inspect outbound traffic to prevent unauthorized data sharing, safeguarding sensitive information from exposure or exfiltration.

For the SaaS applications 1012, the cloud-based system 1000 integrates a cloud access security broker (CASB) that provides granular visibility and control over user activities within SaaS environments. CASB enables organizations to apply context-based access policies, monitor data movement, and enforce compliance with security standards, protecting SaaS environments from data leakage and unauthorized access. The cloud-based system 1000 also includes posture control for SaaS, which continuously assesses application configurations and highlights any security gaps or misconfigurations, ensuring compliance with organizational security policies.

For the cloud services 1014, the cloud-based system 1000 integrates data security posture management (DSPM), which monitors and secures data across public cloud environments. DSPM identifies sensitive data, enforces access policies, and detects misconfigurations or unauthorized access attempts, ensuring that data is protected according to governance standards. This integrated, cloud-native security fabric enables the cloud-based system 1000 to provide secure, policy-driven access across all endpoints and applications, supporting robust, adaptive protection and seamless connectivity across distributed environments.

The cloud-based system 1000 enforces a variety of policy actions to ensure secure and compliant connectivity between endpoints and resources. These policies are designed to govern access, control data movement, and mitigate threats based on real-time analysis of traffic, user behavior, and device posture. Below are examples of typical policy actions the platform may apply, along with the type of data captured in logs to provide a comprehensive record of activity and enforcement.
(1) Access Control Policies: These policies determine who can access specific applications or resources based on the user's role, device type, location, and security posture. For example, an employee accessing a sensitive financial application from a corporate device may be granted access, while attempts from personal or untrusted devices are blocked. These policies can also restrict access based on geolocation or time of day, preventing unauthorized access from certain regions or during off-hours.
(2) DLP Policies: DLP policies inspect outgoing traffic to prevent the unauthorized transfer of sensitive data, such as customer information or financial records. For example, a policy might prevent employees from uploading files containing personally identifiable information (PII) to unsanctioned cloud storage services or sharing confidential documents via email outside the company network. This policy action ensures that sensitive data stays within secure channels, reducing the risk of data breaches.
(3) Threat Protection Policies: The cloud-based system 1000 employs threat protection policies that scan traffic for malicious content, such as malware or phishing attempts. For instance, if an employee attempts to download an unverified file from the Internet, the Zero Trust Exchange may block the download and quarantine the file for further inspection. Additionally, it can perform SSL/TLS inspection on encrypted traffic to identify hidden threats and block high-risk sites, preventing malware or malicious payloads from reaching endpoints.
(4) Application-Specific Controls: These policies allow fine-grained control over specific applications, such as blocking risky features within an application or enforcing read-only access for certain users. For example, access to high-risk administrative functions in a SaaS application may be restricted to authorized personnel only, while other users may receive a restricted, view-only experience.
(5) Conditional Access Policies: These policies grant or restrict access based on conditions such as device compliance status or recent security events. For instance, if a device is found to be non-compliant (e.g., lacking a required security update), the cloud-based system 1000 may block its access to critical applications until the device is remediated.

Each policy action executed by the cloud-based system 1000 generates detailed log data, which can be used for audit, compliance, and threat analysis purposes. The types of data logged include:
(1) User and Device Information: Logs capture information about the user (e.g., username, role, department) and device (e.g., device type, OS version, compliance status) involved in each transaction. This data helps security teams understand who accessed or attempted to access specific resources.
(2) Time and Location Details: Every action is timestamped, with additional details on the location or IP address from which the request originated. This data is essential for detecting unusual patterns, such as logins from unexpected locations or abnormal access times.
(3) Application and Resource Access Data: Logs detail which applications or resources were accessed, including the specific actions taken within the application (e.g., viewing, editing, downloading). This data provides a clear audit trail for monitoring user interactions with sensitive resources.
(4) Threat Detection and Inspection Results: If a threat is detected during traffic inspection, logs will include details of the threat type (e.g., malware, phishing), the detection method used (e.g., signature-based detection, sandbox analysis), and the action taken (e.g., block, quarantine). This data supports post-incident analysis and helps identify patterns in attempted attacks.
(5) Policy Enforcement Outcomes: Each log entry records the outcome of the enforced policy, such as whether access was allowed, blocked, or redirected. If data was restricted due to a DLP policy, the log notes the type of data blocked (e.g., PII, financial information) and the destination it was attempting to reach, offering insights into potential data leakage attempts.
(6) Compliance and Posture Check Results: Logs capture the results of compliance checks, such as whether the device met security requirements (e.g., latest OS patch, active antivirus) before accessing a resource. This information is vital for understanding how effectively security posture controls are being enforced across endpoints.

Through these detailed logs, the cloud-based system 1000 provides security teams with complete visibility into policy enforcement, user behavior, and access patterns, supporting proactive risk management and continuous monitoring of the security posture across the organization.

Data Fabric Integration with a Cloud-Based System

Integrating log data from the cloud-based system 1000 into the security knowledge graph 902 enriches the graph's representation of the organization's security landscape, providing real-time, contextual insights into user behavior, device status, access patterns, and threat incidents. This integration allows the knowledge graph 902 to dynamically correlate and analyze data across different security domains, helping to build a comprehensive view of risk and streamline threat detection and response.

Steps for Integration and Enrichment:
(1) Ingesting and Normalizing Log Data: As log data is continuously generated by the cloud-based system 1000, it is ingested into the security knowledge graph 902 and normalized into a standardized format. This normalization process involves mapping key data fields—such as user identity, device ID, application accessed, location, time, and action taken—into specific node and edge attributes within the graph. For instance, a log entry representing a user's access to a sensitive application could be mapped to create or update edges between the user node and the application node, capturing the access timestamp and location.
(2) Creating and Updating Entity Nodes: Log data helps maintain up-to-date representations of various entities within the knowledge graph. When new users, devices, or applications are detected in the logs, the graph dynamically creates new nodes for these entities. If existing entities are referenced in the logs, the graph 902 updates their attributes, such as device compliance status or recent activity timestamps, ensuring that each node reflects the latest state of its corresponding real-world entity.
(3) Enriching Relationships with Contextual Information: Each log entry provides additional context that enriches the relationships (edges) between entities in the graph 902. For example, if a log shows that a user accessed a sensitive resource from an unauthorized device, the graph can link the user node to the device node with an edge labeled “unauthorized access attempt,” recording details such as the location, time, and policy enforced. This enriched context enables the graph to reflect not just who or what accessed a resource, but also under what conditions and with what policy outcomes.
(4) Adding Threat Intelligence and Anomaly Detection Signals: Log data containing threat detection results—such as malware detection or DLP events—can be added to the knowledge graph 902 as security events, creating nodes or updating edges between affected entities. If malware is detected on a device, for instance, the graph 902 would update the device node with a “malware infection” status and create a threat node representing the malware. Anomaly detection models can run on this enriched graph data to identify suspicious patterns, like repeated failed login attempts from the same IP or sudden access spikes to critical assets, flagging these patterns for further investigation.
(5) Generating Risk Scores and Priority Indicators: The security knowledge graph 902 can analyze the integrated log data to calculate risk scores for various entities, such as users, devices, and applications. For example, if multiple high-severity DLP events are logged for a particular user, the graph 902 can raise that user's risk score and visually represent it with indicators like “high-risk user.” Risk scores and priorities can be dynamically adjusted as new log data is ingested, helping security teams to focus on the most significant risks.
(6) Automating Response Actions through Workflow Triggers: With the knowledge graph enriched by real-time log data, automated workflows can be triggered based on certain patterns or thresholds. For instance, if the graph 902 identifies a high-risk device with multiple malware detections, it could trigger a workflow to isolate the device from the network, alert the security team, and initiate additional scanning. These automated responses help to contain threats quickly and maintain a secure environment.

Integrating log data into the security knowledge graph 902 provides a live, interconnected view of security events and policy enforcement, making it easier to detect and understand threat pathways. Security teams gain visibility into how different entities interact under various conditions, providing valuable insights for incident response, compliance monitoring, and risk management. By continuously updating the knowledge graph with log data, organizations can maintain a highly detailed, contextualized view of their security posture, supporting proactive and adaptive security operations.

### Example Integrations

The following describes some example integrations between the cloud-based system 1000 and the data fabric 900 to enhance UVM outcomes.
(1) bring in and contextualize comprehensive asset data, including the state of individual workstations, such as whether connector applications are installed, whether cloud services are enabled, and unique identifiers like UUID, MAC address, machine hostname, and OS version. Additionally, the platform integrates asset ownership information, such as the assigned user's name, department, and company, helping to connect each asset to its responsible owner. By incorporating this detailed asset information into a centralized view, the platform enables dynamic adjustment of vulnerability severity scores based on mitigating factors—for example, lowering risk scores if the cloud services are installed on the device, providing added layers of protection. The platform also facilitates accurate vulnerability ownership by associating each vulnerability with its proper asset owner, making it easier to prioritize remediation efforts. Furthermore, the data fabric 900 can merge or deduplicate data by correlating identifiers, like MAC addresses, across multiple data sources to prevent duplicate records and create a consolidated, reliable asset inventory. This enriched asset and ownership information helps streamline UVM, supporting faster, more accurate vulnerability assessment and remediation across the organization.
(2) a detailed software bill of materials (SBOM), which provides a complete inventory of assets in the environment and the specific software installed on each one. This includes software versions and patch levels, ensuring visibility into each asset's software landscape. Additionally, the platform incorporates user context, capturing information about who is actively using each asset, as well as details on when and where the asset is being accessed. By combining SBOM data with user context, the data fabric 900 enables robust reporting on software inventory status across the organization, allowing security teams to easily identify all assets running a particular software version. This visibility also enables the platform to automatically flag assets running end-of-life (EOL) software, alerting teams to critical vulnerabilities associated with outdated versions that are no longer supported with security patches. This comprehensive view of software and user context supports more accurate vulnerability assessments and helps prioritize remediation efforts based on real-time asset usage and software risk factors, ultimately strengthening the organization's security posture.
(3) configuration data and event logs to provide a nuanced view of each asset's security posture. The platform collects configuration data at the account level, detailing active policies, settings, and rules, such as whether actions like downloading/uploading large files or accessing specific websites are blocked. Additionally, the data fabric 900 records user event data, assigning risk scores to potentially risky activities (e.g., attempts to access blocked IPs or URLs as per cloud service policies). By using configuration data, the system can adjust risk calculations—either lowering or raising asset vulnerability scores based on the presence of security policies, like data upload/download restrictions, that mitigate risk. This integration also allows the platform to correlate connector application data with configuration policies, identifying instances where a security policy exists but is not enforced (e.g., if cloud services not installed on a device, leading to a higher risk score). Additionally, the data fabric 900 aggregates individual event risk scores to compute an overall risk score for each user or device, reflecting cumulative risk factors and allowing the system to adjust asset severity scores accordingly. This approach gives security teams a dynamic, real-time view of risk that accounts for both policy enforcement and user behavior, enabling them to prioritize high-risk assets for remediation and improve overall security posture.
(4) data on policies established within private SaaS applications used by the organization. This data includes details about specific security policies, permissions, and access controls within each SaaS application, such as data-sharing restrictions, user authentication requirements, and access limitations based on roles or locations. By continuously monitoring adherence to these policies, the platform can dynamically adjust vulnerability scores for associated assets. For example, if a critical data protection policy is enforced within a SaaS application, the cloud-based system 1000 may lower the risk score for assets using that application, reflecting the reduced vulnerability. Conversely, if an essential security policy is missing or not followed, the risk score can be raised, indicating a higher exposure level. This nuanced scoring based on policy adherence enables security teams to focus on assets at the greatest risk, providing a more accurate and prioritized approach to vulnerability management across the organization.
(5) data on misconfigurations and exposures across the organization's digital environment. This includes identifying misconfigurations such as outdated transport layer security (TLS) protocols and expired secure sockets layer (SSL_certificates, which can weaken encryption and leave applications vulnerable to interception or attacks. Additionally, the platform monitors exposures by tracking applications and software with publicly identifiable vulnerabilities—such as outdated versions of web server software that have known security flaws. By gathering and analyzing this data, the UVM solution generates actionable findings for security teams, enabling them to track and manage these issues within a centralized platform. Each finding highlights specific vulnerabilities and misconfigurations, allowing teams to prioritize and remediate high-risk exposures quickly. This proactive identification and continuous tracking of misconfigurations and exposures help reduce the attack surface and maintain a resilient security posture across the organization's network and applications.
(6) detailed data about data stores within the organization's environment, including information on the type of data held in each store, whether it is sensitive, and the status of security measures like encryption. By assessing each data store's content and protection level, the platform can identify potential risks—such as sensitive data that lacks encryption, which could be vulnerable to unauthorized access or exposure. These findings are then recorded and managed within the UVM system, allowing security teams to track, prioritize, and remediate risks associated with unprotected or improperly secured data. This comprehensive visibility into data store configurations and protections enables proactive management of sensitive information, helping to reduce exposure risks and strengthen overall data security within the organization.

### Computing Device

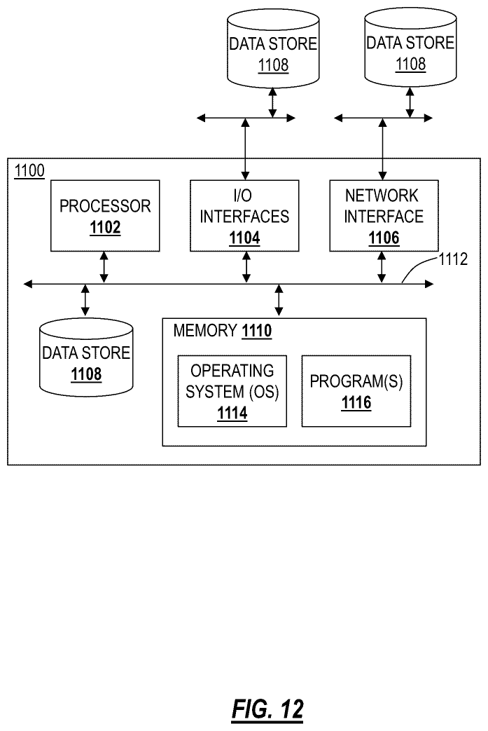

FIG. 12 illustrates a block diagram of a computing device 1100, which may be used in the computing environment 110, the cloud-based system 1000, as well as any of the systems described herein. The computing device 1100 may be a digital computer that, in terms of hardware architecture, generally includes a processor 1102, input/output (I/O) interfaces 1104, a network interface 1106, a data store 1108, and memory 1110. It should be appreciated by those of ordinary skill in the art that FIG. 12 depicts the computing device 1100 in an oversimplified manner, and a practical embodiment may include additional components and suitably configured processing logic to support known or conventional operating features that are not described in detail herein. The components (1102, 1104, 1106, 1108, and 1110) are communicatively coupled via a local interface 1112. The local interface 1112 may be, for example, but not limited to, one or more buses or other wired or wireless connections, as is known in the art. The local interface 1112 may have additional elements, which are omitted for simplicity, such as controllers, buffers (caches), drivers, repeaters, and receivers, among many others, to enable communications. Further, the local interface 1112 may include address, control, and/or data connections to enable appropriate communications among the aforementioned components.

The processor 1102 is a hardware device for executing software instructions. The processor 1102 may be any custom made or commercially available processor, a Central Processing Unit (CPU), an auxiliary processor among several processors associated with the computing device 1100, a semiconductor-based microprocessor (in the form of a microchip or chipset), or generally any device for executing software instructions. When the computing device 1100 is in operation, the processor 1102 is configured to execute software stored within the memory 1110, to communicate data to and from the memory 1110, and to generally control operations of the computing device 1100 pursuant to the software instructions. The I/O interfaces 1104 may be used to receive user input from and/or for providing system output to one or more devices or components.

The network interface 1106 may be used to enable the computing device 1100 to communicate on a network. The network interface 1106 may include, for example, an Ethernet card or adapter or a Wireless Local Area Network (WLAN) card or adapter. The network interface 1106 may include address, control, and/or data connections to enable appropriate communications on the network. A data store 1108 may be used to store data. The data store 1108 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof.

Moreover, the data store 1108 may incorporate electronic, magnetic, optical, and/or other types of storage media. In one example, the data store 1108 may be located internal to the computing device 1100, such as, for example, an internal hard drive connected to the local interface 1112 in the computing device 1100. Additionally, in another embodiment, the data store 1108 may be located external to the computing device 1100 such as, for example, an external hard drive connected to the I/O interfaces 1104 (e.g., SCSI or USB connection). In a further embodiment, the data store 1108 may be connected to the computing device 1100 through a network, such as, for example, a network-attached file server.

The memory 1110 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 1110 may incorporate electronic, magnetic, optical, and/or other types of storage media. Note that the memory 1110 may have a distributed architecture, where various components are situated remotely from one another but can be accessed by the processor 1102. The software in memory 1110 may include one or more software programs, each of which includes an ordered listing of executable instructions for implementing logical functions. The software in the memory 1110 includes a suitable Operating System (O/S) 1114 and one or more programs 1116. The operating system 1114 essentially controls the execution of other computer programs, such as the one or more programs 1116, and provides scheduling, input-output control, file and data management, memory management, and communication control and related services. The one or more programs 1116 may be configured to implement the various processes, algorithms, methods, techniques, etc. described herein.

Those skilled in the art will appreciate any of the devices described herein can be implemented using the computing device 1100. In an embodiment, one or more computing devices 1100 can be used to implement the computing environment 110, the unification environment 130, the data fabric 900, the cloud-based system 1000, and the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase SaaS is sometimes used to describe application programs offered through cloud computing. A common shorthand for a provided cloud computing service (or even an aggregation of all existing cloud services) is “the cloud.” The cloud-based system 1000 is illustrated herein as an example embodiment of a cloud-based system, and other implementations are also contemplated.

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### CAASM, CTEM, AEM

The present disclosure utilizes a data fabric-based approach designed to significantly enhance asset visibility and management consistency across an organization's cybersecurity and IT infrastructure. Currently, organizations leverage multiple methodologies to address asset management and risk mitigation, notably Cyber Asset Attack Surface Management (CAASM), Continuous Threat Exposure Management (CTEM), and Asset Exposure Management (AEM). While CAASM, CTEM, and AEM are presented as examples, those skilled in the art will appreciate that the data fabric-based approach contemplates various additional uses for cybersecurity. Also, while specific examples are described herein for CAASM, CTEM, and AEM, those skilled in the art will appreciate these are merely illustrative and the data-fabric approach can be used for any asset visibility and management.

CAASM platforms provide comprehensive visibility and control over an organization's complete asset landscape by consolidating and integrating data from various security and IT management tools into a unified, detailed inventory. This approach systematically identifies, categorizes, and manages all cyber assets, including hardware, software, cloud resources, IoT devices, and other critical resources. Key features include the maintenance of a comprehensive asset inventory, enhanced asset visibility with contextual details, identification of previously unknown or unmanaged assets, and strategic initiatives aimed at reducing the organization's overall attack surface. A typical CAASM use case allows organizations to rapidly ascertain the existence and security posture of their assets, providing clarity and assurance regarding asset security and proper configuration.

CTEM, on the other hand, emphasizes continuous monitoring and proactive management of vulnerabilities, threats, and exposures across the enterprise landscape. CTEM platforms are dedicated not only to asset visibility but specifically to the ongoing identification, prioritization, and remediation of vulnerabilities, enabling proactive risk management. Essential capabilities of CTEM include continuous scanning for vulnerabilities and emerging threats, prioritization of threats based on their potential impact and criticality, proactive measures for reducing risk exposure, and integration of efficient remediation workflows. In practice, CTEM empowers security teams to maintain continuous oversight of threat exposure, prioritize addressing high-risk vulnerabilities, and implement timely remediation actions.

AEM represents a specialized approach concentrating explicitly on managing and mitigating risks associated with exposed or vulnerable assets. While CAASM focuses broadly on comprehensive visibility, AEM specifically addresses assets known to have vulnerabilities or misconfigurations, thereby enabling targeted risk prioritization and actionable remediation. Key functionalities of AEM include identifying exposed or vulnerable assets, contextualizing exposure data to understand asset-specific risk profiles, prioritizing remediation efforts based on assessed risk levels, and reducing attack surfaces by effectively remediating high-risk assets. A primary use case of AEM is to minimize organizational risk by specifically managing vulnerabilities affecting critical or highly exposed assets.

In summary, each platform serves distinct yet complementary roles within an organization's cybersecurity strategy. CAASM provides centralized, comprehensive visibility and inventory of all cyber assets to effectively manage the total attack surface. CTEM specializes in continuous vulnerability management through proactive threat identification, prioritization, and remediation. AEM focuses explicitly on identifying and mitigating vulnerabilities and exposures on critical or vulnerable assets through targeted, risk-based strategies. Collectively, integrating these methodologies enhances overall cybersecurity posture by ensuring thorough asset visibility, proactive vulnerability mitigation, and targeted risk remediation.

### Asset Visibility and Management System

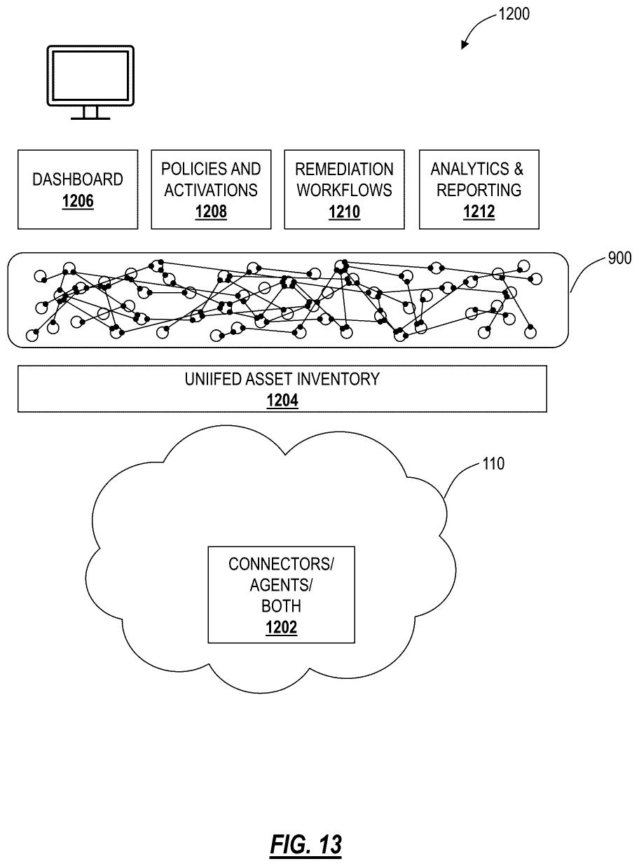

FIG. 13 illustrates an example implementation of an asset visibility and management system 1200 operatively connected to and configured to monitor a computing environment 110. The system 1200 can, for instance, implement functionalities similar to CAASM, CTEM, AEM, or other comparable cybersecurity management approaches. The asset visibility and management system 1200 includes several components: data collectors 1202, a unified asset inventory 1204, the data fabric 900, a centralized dashboard 1206, policies and activations 1208, remediations and workflows 1210, and analytics and reporting 1212.

The data collectors 1202 gather information from the computing environment 110 either by using connectors to ingest data directly from existing IT and cybersecurity tools, deploying discovery agents directly on managed assets, or a combination of both. This flexibility ensures comprehensive asset discovery across diverse technological environments. The collected data feeds into a centralized overview dashboard 1206, providing high-level, consolidated visualizations of asset discovery, asset types, operating systems, and software installations. Additionally, the dashboard presents critical information such as newly discovered or previously unmanaged assets, risk scores assessing the cybersecurity posture of individual or grouped assets, tool coverage statistics indicating how comprehensively the environment is monitored, and summaries of urgent policy violation alerts requiring immediate attention.

The unified asset inventory 1204 serves as a single authoritative source containing detailed records of all organizational assets. It aggregates comprehensive information regarding endpoints, cloud infrastructure, IoT devices, networking equipment, installed software applications, and user identities (including users, groups, roles, and accounts). Asset information within the inventory is typically deduplicated, correlated, and intelligently resolved from multiple overlapping data sources, thereby ensuring accuracy, consistency, and completeness of asset details.

To support deep investigations and risk assessments, system 1200 includes an asset graph functionality integrated within the unified asset inventory or related interfaces, i.e., the data fabric 900. Asset graphs vary based on specific organizational needs or use cases; they can visually represent intricate relationships between different assets, software components, and user identities. Such graphs may illustrate possible attack vectors, highlight vulnerable pathways within networks, or serve as interactive maps for network topology exploration.

Further, the policies and activations module 1208 facilitates the creation and enforcement of robust cybersecurity policies aimed at reducing organizational risk exposure. Policies defined within this module may include, for example, requirements for endpoint detection and response (EDR) deployment or maintenance of an up-to-date Configuration Management Database (CMDB). When policy violations occur, the system automatically generates targeted alerts, which typically trigger integrated workflows in IT Service Management (ITSM) tools or other cybersecurity platforms to initiate timely risk mitigation efforts. Complementing this, the remediations and workflows module 1210 provides structured and predefined processes for addressing identified security or configuration issues, thereby streamlining resolution and enhancing response efficiency.

Lastly, the analytics and reporting module 1212 provides critical insights via predefined and customizable reports and dashboards. These analytics serve multiple stakeholders, from management-level executives to individual contributors, fulfilling diverse requirements such as compliance reporting, performance tracking, risk assessment, and strategic cybersecurity decision-making. By leveraging robust analytics capabilities, organizations gain enhanced visibility into their cybersecurity posture, enabling informed prioritization and strategic allocation of security resources.

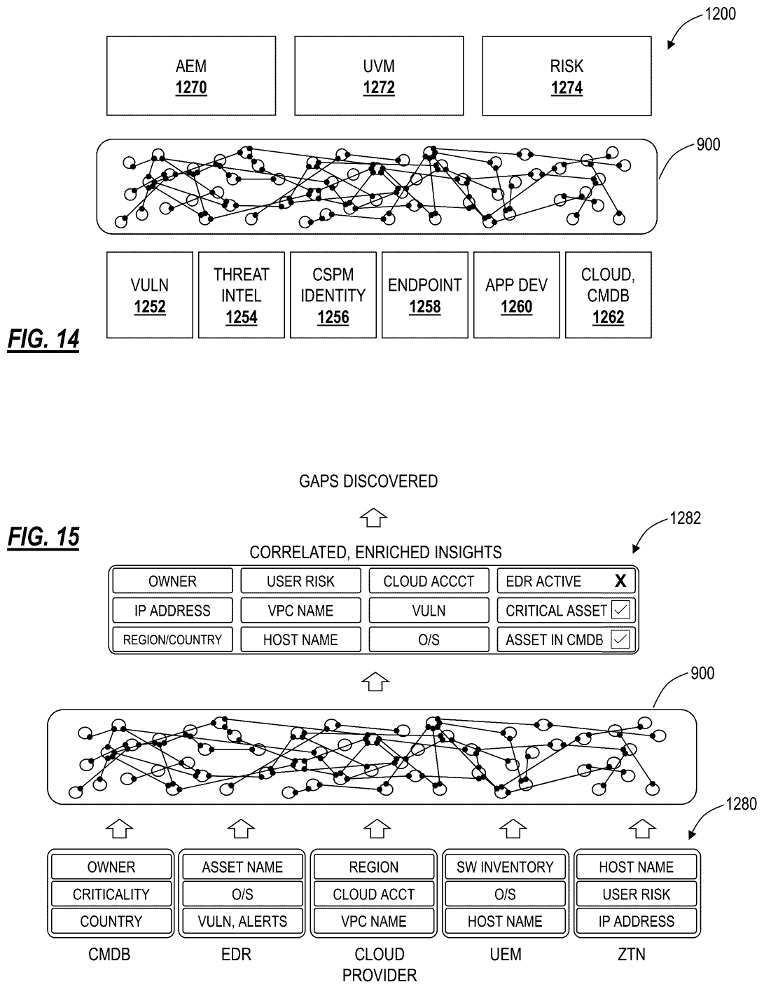

FIG. 14 illustrates the data fabric 900 as implemented to provide robust asset visibility and management capabilities within the system 1200. Specifically, FIG. 14 offers a logical depiction of the role data fabric 900 plays in delivering comprehensive threat exposure management and related cybersecurity functionality. The data fabric 900 ingests diverse data from a variety of sources, including but not limited to vulnerability databases 1252, threat intelligence feeds 1254, Cloud Security Posture Management (CSPM) and identity-related data 1256, endpoint telemetry data 1258, application development and operations data 1260, cloud infrastructure, and Configuration Management Database (CMDB) data 1262, among others. These sources encompass both data internal to the cloud environment 110 and external information from third-party vendors or additional external resources. By integrating such extensive and varied datasets into a unified fabric, the data fabric 900 provides a rich, correlated foundation to support advanced cybersecurity analytics.

At a logical level, the asset visibility and management system 1200 builds various cybersecurity applications upon the foundational capabilities of the data fabric 900. These applications include, but are not limited to, an AEM application 1270, a UVM application 1272, and a risk management application 1274. Through leveraging the underlying data fabric 900—which serves simultaneously as both a centralized data source and a sophisticated analytic engine capable of graph-based relationship analysis—these specialized cybersecurity applications enhance organizational risk awareness, vulnerability visibility, and remediation effectiveness.

The AEM application 1270 leverages the data fabric 900 to integrate, correlate, and enrich information from hundreds of distinct data streams, including data from the cloud-based system 1000. By aggregating such extensive datasets, the AEM application 1270 delivers a precise, comprehensive inventory of organizational assets and their corresponding cybersecurity risks. In an example embodiment, the cloud-based system 1000 processes in excess of 500 billion security-related transactions daily, facilitating a detailed and continuously updated view of assets and their security posture. Additionally, the system manages telemetry from over 50 million agent-enabled devices, providing deep visibility into asset operations across diverse locations such as branches, manufacturing facilities, and other operational environments within the computing environment 110. Such detailed and extensive telemetry collection supports more precise analytics, ultimately enabling more effective security decisions and outcomes.

Further, the AEM application 1270 provides organizations with comprehensive, actionable asset-risk management capabilities. Specifically, the application enables organizations to create an accurate asset inventory by aggregating and deduplicating asset data from multiple overlapping sources, thus presenting a unified and complete view of organizational assets and their associated software stacks. The application also identifies security coverage gaps, such as assets lacking essential cybersecurity solutions (e.g., endpoint detection and response solutions) or those with outdated software versions. Moreover, AEM improves data accuracy and consistency by automating the updating of CMDB records and resolving data discrepancies across multiple systems. Lastly, it actively mitigates risks by triggering automated remediation workflows and adjusting policies dynamically, such as limiting or revoking access for users tied to high-risk or compromised assets, thereby proactively lowering organizational risk.

The AEM application 1270 provides a robust framework for securing enterprise environments by offering a dynamically updated, high-fidelity “golden record” of all organizational assets. This consolidated record is continuously enriched with data from dozens of source systems, ensuring accurate asset resolution that underpins a holistic and reliable asset inventory. By correlating and analyzing details across endpoints, networks, cloud resources, and more, AEM pinpoints potential coverage gaps stemming from misconfigurations or missing security controls—critical issues that can expose an organization to heightened risks and compliance failures. Moreover, AEM enables proactive risk mitigation through automated policy enforcement, workflow assignment, and seamless updates to the Configuration Management Database (CMDB), helping security teams not only detect potential threats but also take rapid, targeted action. Ultimately, by shrinking the attack surface and streamlining oversight of asset health, the AEM solution empowers organizations to maintain a stronger cybersecurity posture and operational resilience.

The UVM application 1272 uses the data fabric 900 to streamline and centralize vulnerability management processes. UVM consolidates diverse vulnerability data streams, such as data from vulnerability scanners, security assessments, and threat intelligence feeds, into a cohesive platform. This integrated approach provides organizations with continuous, real-time visibility into vulnerabilities present across endpoints, networks, cloud environments, and applications. UVM applies a consistent, risk-based methodology to prioritize vulnerability remediation efforts effectively. Through comprehensive unified reporting and automated vulnerability management workflows, the UVM application enhances operational efficiency, accelerates response times, ensures adherence to compliance requirements, and substantially reduces overall cybersecurity risk exposure.

The risk application 1274 represents an advanced, comprehensive risk management platform leveraging the data fabric 900 to measure, quantify, and systematically remediate organizational cybersecurity risk. The risk application provides detailed risk measurement data that identifies and quantifies high-risk activities associated with users, system configurations, and external attack surfaces, thereby establishing an extensive, actionable risk management framework. Moreover, it delivers actionable recommendations for risk mitigation through intuitive and streamlined workflows, facilitating efficient risk response actions. The architecture of the risk application incorporates multiple categories of scores—including user risk scores, company-wide risk scores, and configuration-based risk scores—to generate precise, quantifiable risk assessments tailored to organizational context.

Specifically, the risk application 1274 computes organizational risk scores by analyzing internal security data and integrating external vulnerability data sources. By continuously assessing and quantifying risks across key cybersecurity domains, the risk application establishes an industry-leading standard for comprehensive risk measurement and quantification. The application's methodology assesses risks using four primary factors: (1) External Attack Surface, which involves analysis of publicly discoverable variables like exposed servers and Autonomous System Numbers (ASNs) to identify vulnerable cloud assets; (2) Compromise likelihood, derived from comprehensive analysis of security events, configurations, and network traffic patterns; (3) Lateral Propagation risks, calculated by assessing private access configurations and internal network metrics; and (4) Data Loss risks, determined through analysis of sensitive data attributes and configurations to evaluate potential data leakage scenarios. This multifaceted approach ensures the provision of precise, actionable insights and recommendations to reduce cybersecurity risk effectively across the enterprise.

### AEM Via the Data Fabric

FIG. 15 illustrates how the data fabric 900 works in tandem with the AEM application 1270 to consolidate and interpret critical asset data from a wide range of sources 1280. These data sources can include a CMDB capturing details such as owner, criticality, and location; EDR tools providing asset names, operating system types, known vulnerabilities, and relevant alerts; a cloud provider like the cloud-based system 1000 sharing region, cloud account, and Virtual Private Cloud (VPC) information; Unified Endpoint Management (UEM) solutions reporting on software inventories and host names; and Zero Trust Networking (ZTN) platforms offering host name, user risk, and IP address data. Each source feeds the data fabric 900, which organizes and correlates these diverse inputs into a cohesive repository that supports advanced asset monitoring and management functions.

Building on this centralized data, the AEM application 1270 generates correlated and enriched insights 1282 that help uncover potential gaps or vulnerabilities across the organization's infrastructure. These insights incorporate factors such as asset ownership, IP addresses, physical or logical locations, user risk scores, VPC identifiers, host names, cloud accounts, operating systems, EDR status, and whether particular assets appear in the CMDB or are deemed critical. For example, the AEM application 1270 may identify a high-risk user operating on an inadequately protected endpoint, prompting an automated policy action within the ZTN system to restrict that user's network access. In another instance, it might detect incomplete CMDB fields, triggering a workflow to update and reconcile missing records. Such targeted insights and policy-driven responses illustrate how the AEM application 1270 leverages the data fabric 900 to automate security processes, reduce risk, and maintain a more accurate, up-to-date view of enterprise assets. Additional use cases can be addressed with the same underlying architecture, further enhancing organizational resilience in the face of evolving cyber threats.

### Policies

With the data fabric 900 and its comprehensive threat exposure management capabilities, organizations can define and apply security-related policies aimed at reducing their overall attack surface. The AEM application 1270 leverages this functionality to monitor, detect, and remediate a variety of security and configuration gaps within complex IT environments. Notably, three principal categories of policies ensure robust asset management and heightened security: CMDB Hygiene, Tool Coverage, and Missing Configuration.

CMDB Hygiene. A Configuration Management Database (CMDB) serves as a centralized repository of critical configuration items, including details such as asset owners, asset types, and physical or virtual locations. Policies designed to maintain CMDB hygiene focus on preserving data integrity, consistency, and accuracy within this repository. For instance, they can flag missing information—for example, assets lacking an assigned owner, asset type, or physical location—and identify conflicting asset ownership data. By continuously enforcing CMDB hygiene, organizations can ensure that their configuration records remain up to date, thereby improving the quality of asset intelligence available for security and operational decisions.

Tool Coverage. These policies ensure that critical endpoints, servers, and other IT assets are covered by mandatory security and operational tools. For example, a policy might detect an endpoint missing essential Endpoint Detection and Response (EDR) software or an asset that appears in the organization's network but is absent from the CMDB. Such coverage-focused policies help close visibility gaps, ensuring that all devices and systems within the environment have the required security, monitoring, and management solutions installed and operational.

Missing Configuration. This category highlights situations where key configuration data or security measures are incomplete or absent. Examples include an out-of-date EDR agent that may no longer receive relevant threat intelligence updates or an endpoint agent that users can uninstall without authorization. These types of policies help security teams proactively identify and remediate configuration weaknesses, thus bolstering the organization's overall security posture.

By systematically applying these policies through the AEM application 1270 and enforcing them via the data fabric 900, enterprises can maintain high-fidelity asset records, ensure necessary tool coverage, and promptly address missing or incomplete configuration data. Together, these policy-driven measures significantly reduce cyber risks, streamline security operations, and protect the organization's critical infrastructure from evolving threats.

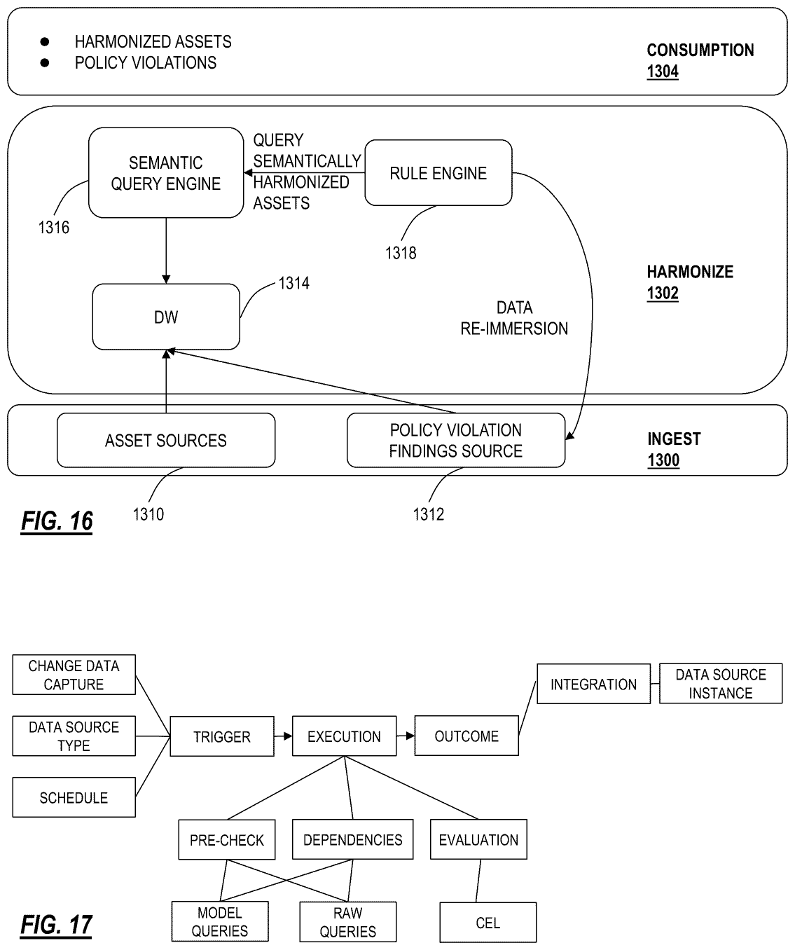

FIG. 16 illustrates an architecture with building blocks over the data fabric 900 for asset management and policy enforcement. The architecture is divided into three primary functional layers: Ingest 1300, Harmonize 1302, and Consumption 1302. At the Ingest 1300 layer, data is gathered from multiple asset sources 1310 and sources 1312 that specifically identify policy violations. These inputs feed into a data warehouse (DW) 1314, which acts as a centralized storage and organization facility for the raw, ingested data.

The Harmonize 1302 layer features two core components: a Semantic Query Engine 1316 and a Rule Engine 1318. The Semantic Query Engine 1316 interacts with the data warehouse 1314 to retrieve semantically harmonized asset data, ensuring consistent understanding and meaningful interpretation across various datasets. Concurrently, the Rule Engine 1318 receives these harmonized assets and applies specific rules to identify potential policy violations or other insights. The Rule Engine 1318 also provides a feedback mechanism termed “Data Re-immersion,” whereby its findings regarding policy violations are re-ingested back into the data warehouse for ongoing enrichment and refinement of data.

At the top level, the Consumption 1304, the outputs generated include clearly defined harmonized assets and policy violations, enabling users or systems to leverage refined, accurate, and actionable insights for improved cybersecurity and asset exposure management decisions.

FIG. 17 illustrates a workflow pipeline composed of three primary sequential stages: Trigger, Execution, and Outcome for policies in the AEM application. The Trigger stage initiates the workflow and may be activated through various conditions such as a predefined schedule, a specific data source type, or via Change Data Capture (CDC) events. Following the trigger, the Execution stage involves multiple operations and checks. These include conducting a Pre-Check, which leverages both model queries and potentially raw queries; managing Dependencies, which may also depend on raw queries; and performing an Evaluation step, utilizing the Common Expression Language (CEL) for decision-making or validation logic.

The final stage, Outcome, represents the results of the workflow execution. This outcome subsequently interacts with external systems through an Integration process, ultimately connecting or updating specific Data Source Instances. Overall, this architecture facilitates automated and dynamic workflow execution with clear stages for initiation, logic processing, and actionable results that integrate seamlessly with external data systems.

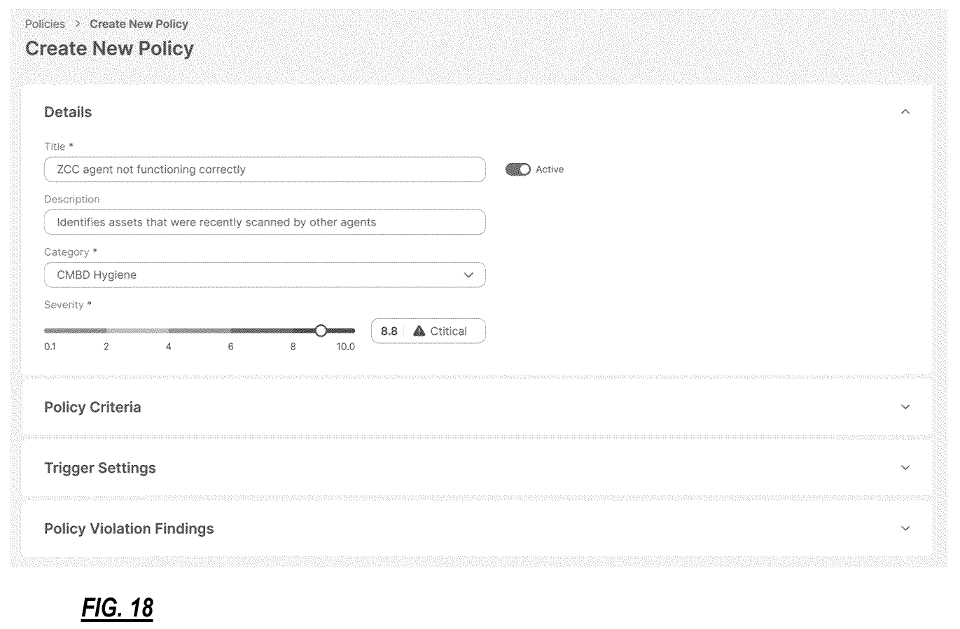

FIG. 18 illustrates a user interface for creating a new security policy in an asset or cybersecurity management platform. The interface includes a “Details” section where the policy's title, description, category, and severity can be defined. Specifically, the example policy titled “ZCC agent not functioning correctly” is described as identifying assets recently scanned by alternative agents. It falls under the category “CMDB Hygiene,” emphasizing data quality and integrity. The severity rating is set at a critical level of 8.8 out of 10, clearly indicating high-risk importance. Additionally, the interface allows toggling the policy's active status. Further expandable sections shown below, labeled “Policy Criteria,” “Trigger Settings,” and “Policy Violation Findings,” suggest additional customization options for policy rules, activation conditions, and management of policy violation results.

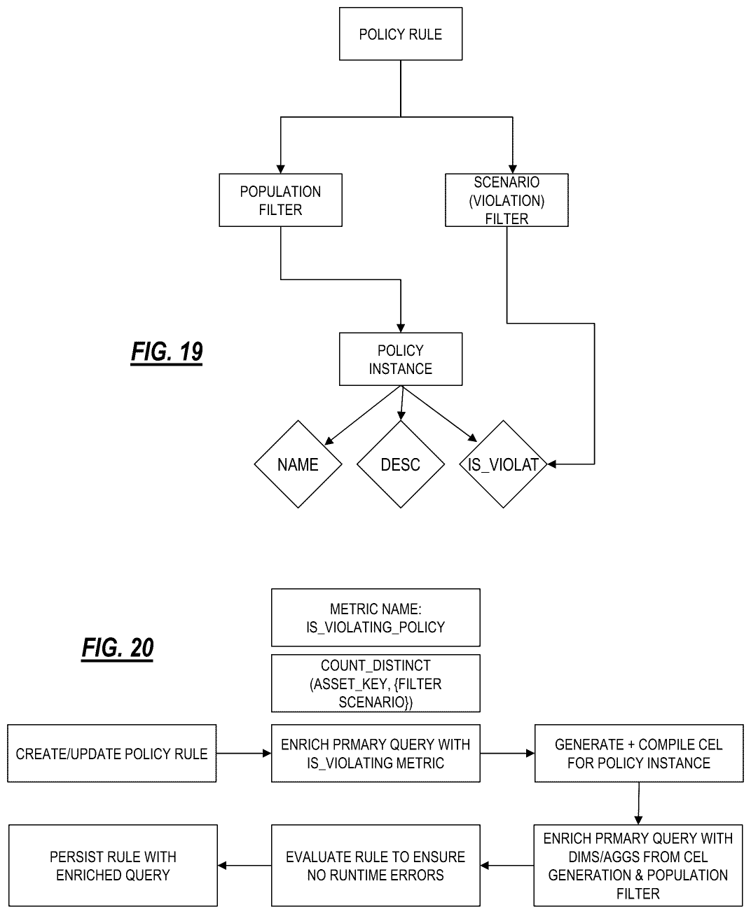

FIG. 19 illustrates a conceptual workflow for calculating policy violations within the data fabric. At the top level, a defined “Policy Rule” branches into two distinct filters: a “Population Filter” and a “Scenario (violation) Filter.” The Population Filter selects all relevant assets that meet general inclusion criteria, identifying the population of assets to evaluate against the policy. These filtered assets then form a “Policy Instance,” which encapsulates the evaluated policy details. Each Policy Instance contains specific attributes, including a name, description (“desc”), and an indicator (“is_violating”) determining whether the instance represents a policy violation. The determination of whether an asset is violating a policy is guided by the Scenario (violation) Filter, which provides the criteria to flag policy breaches explicitly. Thus, the Policy Instance clearly indicates policy compliance status, enabling precise management and tracking of security policy adherence within the data fabric.

FIG. 20 illustrates the detailed workflow for creating, updating, and managing policy rules and their associated violation metrics in a data-driven system. The process begins with the step “Create/Update Policy Rule,” where the policy definition is initially set or modified. Following this, the primary query associated with the policy is enriched by adding an “is_violating” metric, which explicitly captures whether the policy conditions have been breached. Next, the workflow includes generating and compiling the Common Expression Language (CEL) expression specific to the policy instance, allowing dynamic and precise evaluation of compliance conditions. After CEL compilation, the primary query is further enriched with dimensions and aggregations derived from the CEL expression and the associated population filter, ensuring detailed and contextually relevant metrics.

Subsequently, the enriched policy rule undergoes evaluation to verify it executes without runtime errors, ensuring the reliability and accuracy of the policy's logic. Once validated, the enriched and error-free policy rule is persisted within the system for ongoing use. The workflow also explicitly includes the CEL expression, demonstrating how policy instances are programmatically evaluated to determine asset violations. This structured approach enables robust policy management and precise violation detection in the context of the data fabric.

### User Interfaces

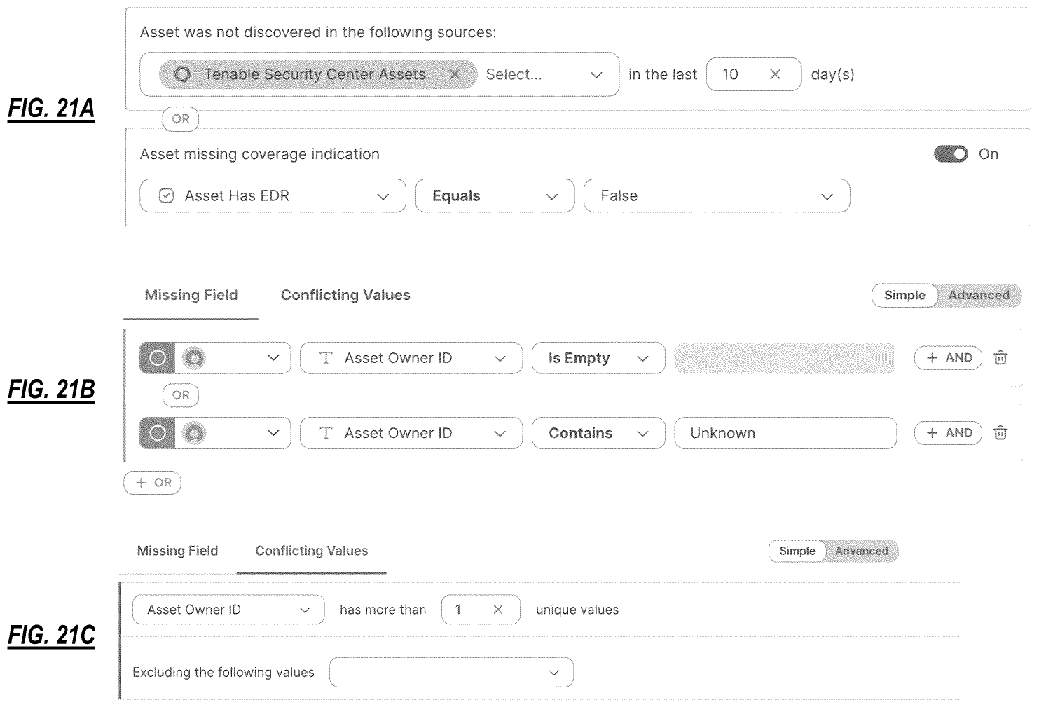

FIGS. 21A-21C illustrates user interfaces showing variations in the filtering structures used for different cybersecurity policy categories within a security management system. It specifically highlights how each policy category employs distinct filters tailored to specific use cases:

In FIG. 21A, under the Tool Coverage category, filters are applied to identify assets that have not been discovered within specific security monitoring tools, such as “Tenable Security Center Assets,” within a defined recent timeframe (e.g., the past 10 days). It also includes criteria to detect assets lacking essential security controls, like missing EDR coverage.

In FIG. 21B, under the CMDB Hygiene—Missing Field category, filters specifically detect scenarios where critical asset details, such as the “Asset Owner ID,” are either empty or explicitly marked as unknown. This approach helps maintain data completeness within the Configuration Management Database (CMDB).

In FIG. 21C, the CMDB Hygiene—Conflicting Values category utilizes filters to highlight scenarios where asset fields, for instance, “Asset Owner ID,” have multiple differing values, thus indicating conflicting or inconsistent data entries. These policies help ensure accurate, reliable, and consistent asset data management across the organization.

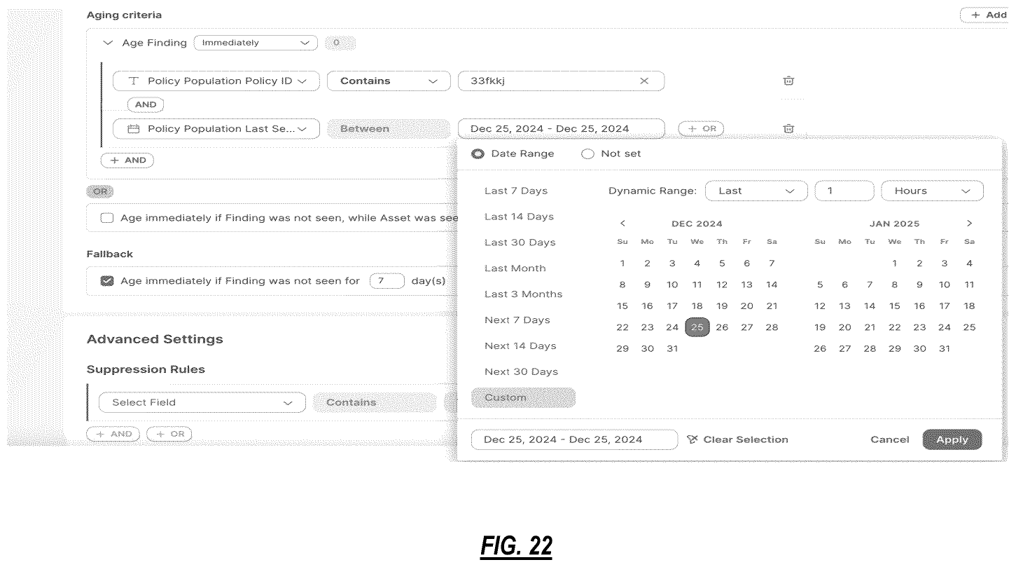

FIG. 22 illustrates a user interface with a dynamic aging rule mechanism used for cybersecurity policy management. Specifically, the illustrated solution enables policy alerts (“policy pops”) to age out or expire based on customizable criteria, defined primarily by two parameters: the specific Policy ID and the time elapsed since the alert was last observed (“Last seen”). FIG. 22 demonstrates an interactive configuration interface where users define these aging criteria, for instance, selecting a particular policy ID and specifying a timeframe in minutes or days after which a policy finding should be aged or marked as resolved if not observed again. Additionally, the interface provides advanced settings, including fallback conditions and suppression rules, enhancing flexibility in managing alert lifecycle and ensuring that policy violations reflect real-time asset states accurately and efficiently.

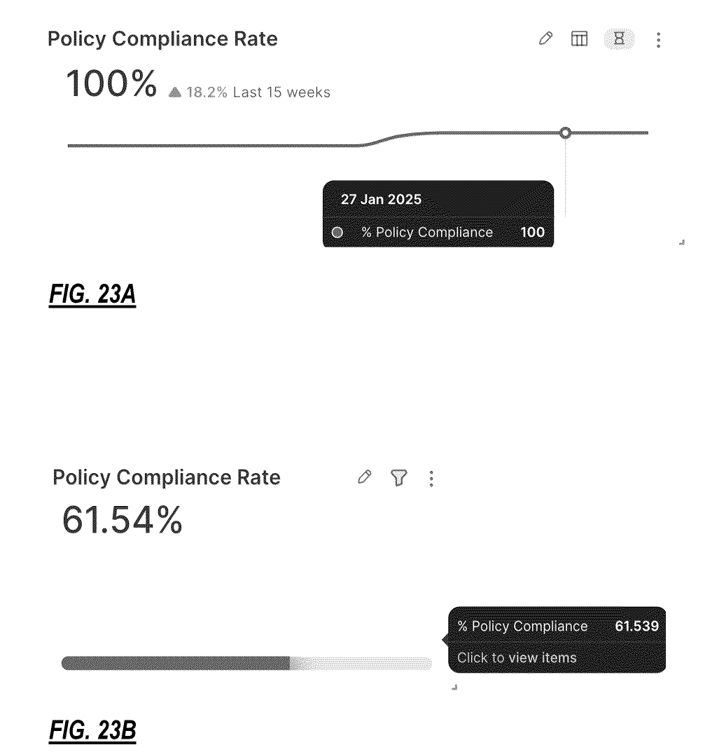

FIGS. 23A-23B illustrate widgets presented in a user interface, such as the dashboard 1206, including a trend line widget (FIG. 23A) and a progress bar tile widget (FIG. 23B). The trend line widget visually represents how a selected metric changes or evolves over a specified time period. It allows users to customize the displayed information by selecting a specific time range, determining how the data is categorized or broken down, and choosing the particular metric to track. The progress bar tile widget provides an alternative visual presentation specifically suited for percentage-based metrics. When the metric selected by the user is expressed as a percentage, this widget allows the value to be displayed as a graphical progress bar rather than merely as a numerical percentage, offering clearer and more immediate insights into the metric's relative completion or attainment status.

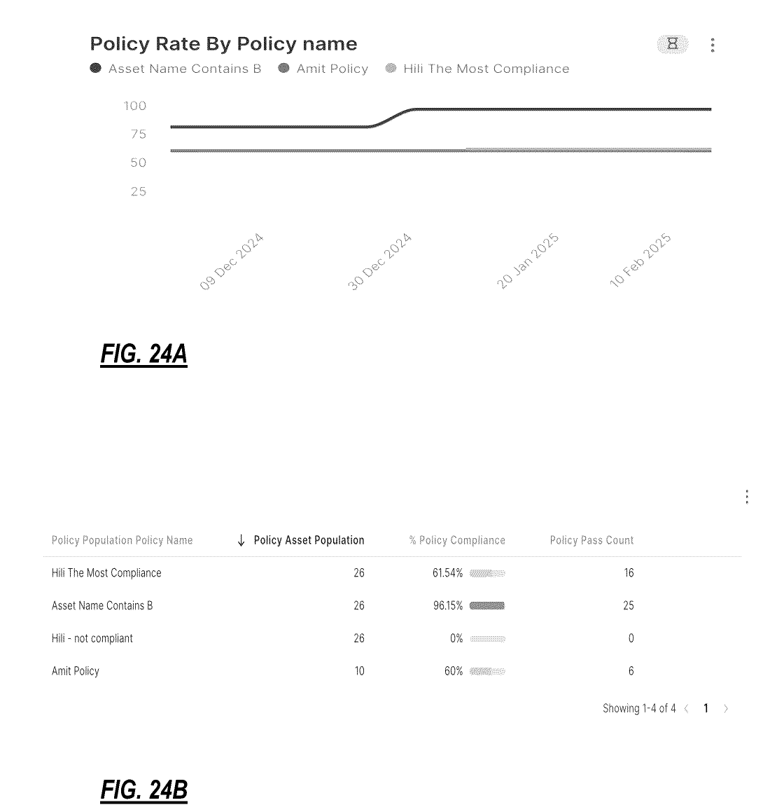

FIGS. 24A-24B illustrate example widgets presented within a user interface, such as the dashboard 1206, specifically including a Multi-dimension Line widget (FIG. 24A) and a Table Widget Column formatter (FIG. 24B). The Multi-dimension Line widget visually represents how a chosen metric evolves over a defined time range and enables users to breakdown this data by an additional dimension for enhanced analytical depth. For instance, a practical use case could involve tracking the policy compliance rate over the last three months, with the data further segmented weekly and by individual policy names to identify patterns and trends effectively. The Table Widget Column formatter enhances the readability and interpretability of data displayed in tables by supporting diverse visualization formats for table columns. It allows users to select appropriate display styles tailored to the metric type, thereby improving the overall clarity and customization of the presented tabular data.

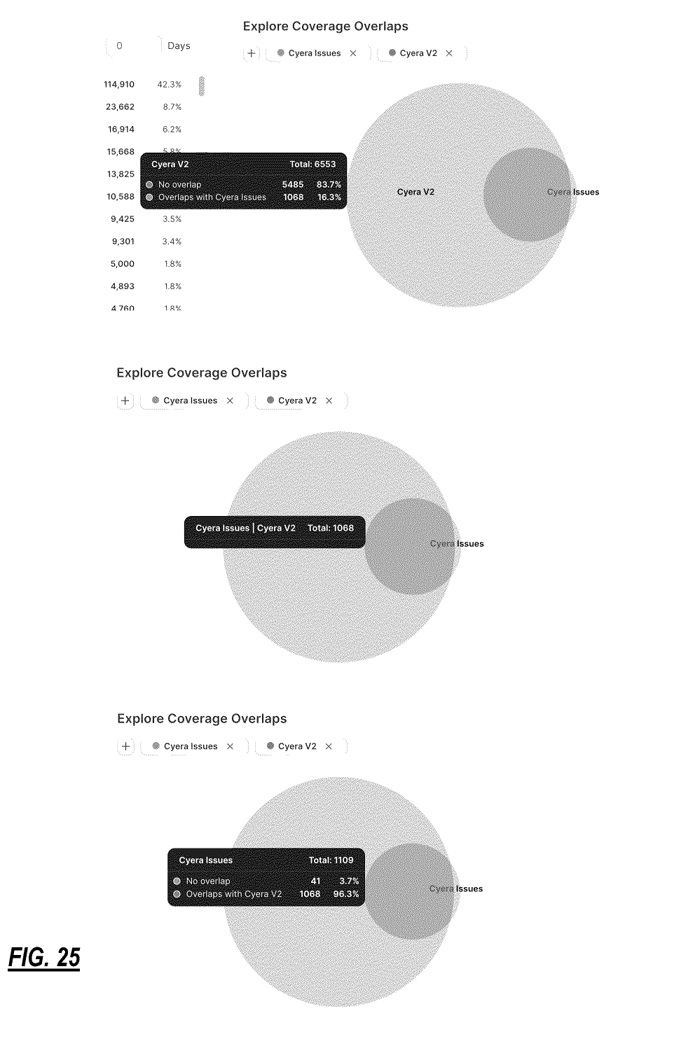

FIG. 25 illustrates a user interface displaying example Venn diagrams. These diagrams effectively visualize the overlap and intersection between different groups, providing users with clear insights into the relationships and commonalities among data sets. This visualization specifically supports repeated dimensions, allowing detailed exploration of how various data categories intersect. For instance, a practical use case could involve examining “Asset Sources Overlap,” where the Venn diagram shows the number of assets originating from each individual source, as well as clearly highlighting the size of the overlap among the different asset sources. This provides a concise graphical representation to better understand asset distribution and commonality across multiple sources.

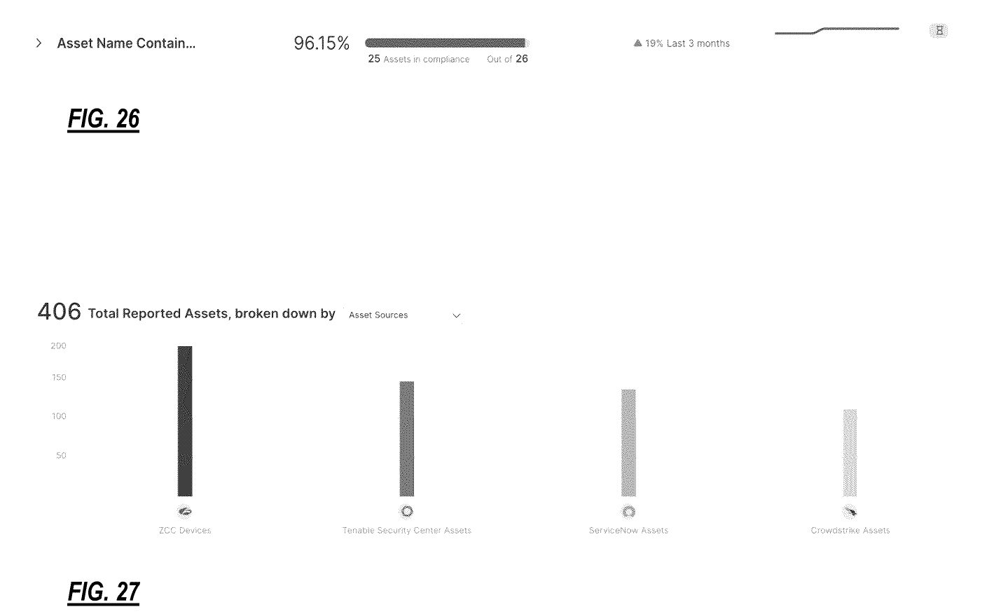

FIG. 26 illustrates a Policy Compliance Dashboard designed to monitor the state of various policies defined within an account. The dashboard prominently displays the current compliance rate associated with each individual policy, offering users an immediate overview of compliance status. Additionally, it provides visual insights into compliance trends over a user-selected time frame, allowing stakeholders to quickly identify changes and patterns in policy adherence. For more comprehensive and granular analysis, the dashboard also includes a detailed table view, enabling users to break down compliance data further by additional dimensions, facilitating targeted insights and precise compliance management.

FIG. 27 illustrates an Asset Inventory Dashboard designed to provide a comprehensive view of all organizational assets. This dashboard prominently displays asset information using multiple breakdowns and categorizations, allowing users to easily visualize and understand asset distribution across different dimensions. The dashboard helps clients effectively track, analyze, and manage their asset portfolios, facilitating informed decision-making and improved operational oversight.

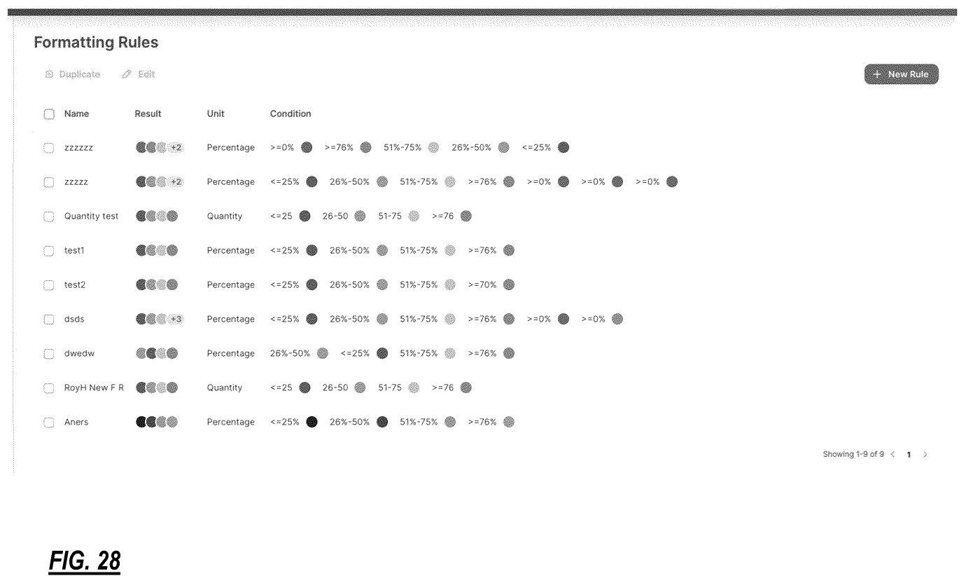

FIG. 28 illustrates a user interface featuring formatting rules intended to enhance metric visualization within widgets. This functionality allows users to dynamically apply configurable color rules based on specific value ranges, significantly improving visual clarity and interpretability of data. By mapping distinct colors to defined metric thresholds, the interface provides immediate, intuitive feedback about the metric's current status, facilitating quicker assessment and response. The color-coding effectively conveys the sentiment or urgency related to metric behavior, aiding users in rapidly identifying areas of concern or interest.

### Method for Continuous Exposure and Attack Surface Management

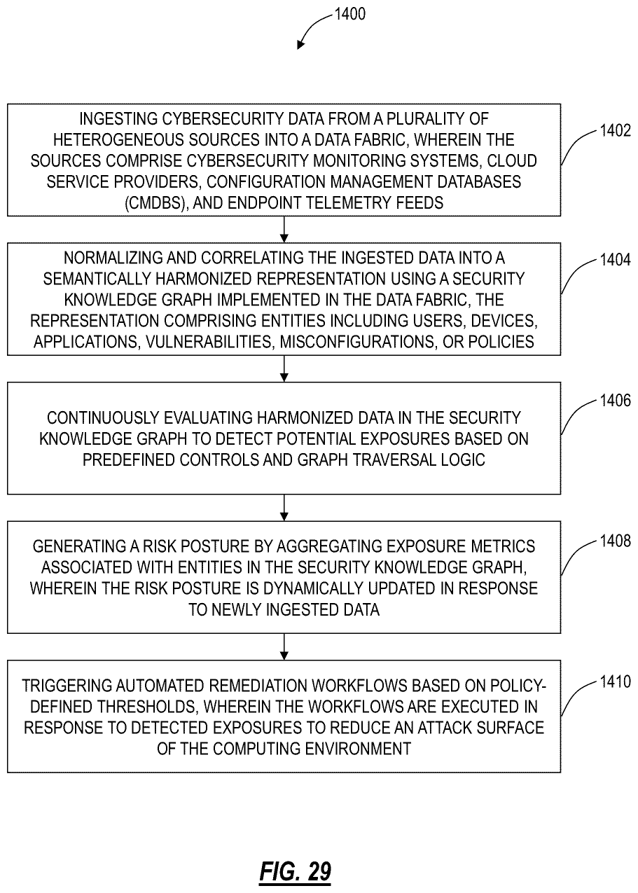

FIG. 29 illustrates an example flowchart of a computer-implemented method 1400 for continuous exposure and attack surface management in an enterprise computing environment using a unified, integrated approach enabled by a data fabric. The method 1400 includes ingesting cybersecurity-related data from multiple heterogeneous sources, where heterogeneous sources refer to diverse and disparate data-generating systems that differ significantly in data formats, structures, schemas, operational characteristics, and the types of information provided (step 1402). Such heterogeneous sources include, without limitation, cloud computing platforms, identity and access management (IAM) services, threat intelligence feeds, vulnerability scanning tools, configuration management databases (CMDBs), cloud security posture management (CSPM) tools, and endpoint telemetry platforms.

In addition, the disclosed embodiments leverage data from a plurality of cybersecurity monitoring systems, which are specialized tools and platforms designed to identify, analyze, prevent, and respond to cybersecurity threats. Cybersecurity monitoring systems include endpoint detection and response (EDR) systems, intrusion detection and prevention systems (IDS/IPS), security information and event management (SIEM) platforms, external attack surface management (EASM) tools, vulnerability scanners, user and entity behavior analytics (UEBA), network traffic analysis (NTA) tools, and other security-focused solutions. These cybersecurity monitoring systems generate security alerts, scan results, event logs, and other security-relevant data, providing visibility into vulnerabilities, exposures, threats, user activities, configurations, and overall cybersecurity posture.

Once ingested, the data from these heterogeneous sources and cybersecurity monitoring systems is normalized, correlated, deduplicated, and integrated into a semantically harmonized representation (step 1404). A semantically harmonized representation is a coherent, unified data model that reconciles and resolves semantic and syntactic differences across diverse data sources, enabling consistent interpretation and contextual alignment of data points. This representation may take the form of a security knowledge graph, which includes interconnected nodes and edges representing entities such as assets, users, vulnerabilities, threats, configurations, software components, and their relationships. The harmonization process ensures data consistency, completeness, and interoperability across the integrated dataset, enabling advanced analytics and automated responses to cybersecurity exposures and vulnerabilities.

Utilizing this semantically harmonized representation, the disclosed embodiments perform comprehensive cybersecurity exposure and vulnerability analysis, dynamically assessing the organization's risk posture (steps 1406, 1408). Risk posture refers to a real-time, contextualized assessment of the overall cybersecurity risk exposure faced by an organization. The risk posture is calculated based on aggregated and correlated security metrics, including asset vulnerabilities, threat intelligence, asset criticality, user and entity behavior, control coverage gaps, external exposure, policy compliance status, and historical security events. The risk posture assessment provides a holistic and actionable view of cybersecurity threats and exposures across the computing environment, enabling proactive identification of high-risk areas requiring immediate attention.

In response to identified exposures and vulnerabilities exceeding predetermined thresholds or risk criteria, the disclosed embodiments further include initiating automated remediation workflows (step 1410). These workflows may encompass policy-based controls such as isolating compromised or at-risk assets, triggering software updates, revoking inappropriate access, assigning ownership to orphaned assets, updating CMDB records, or generating security incident response tickets in external IT service management (ITSM) systems.

Additional embodiments specifically contemplate unified vulnerability management (UVM) capabilities, wherein vulnerabilities identified from multiple scanners and monitoring systems are continuously correlated against the semantically harmonized asset inventory, providing centralized visibility into vulnerabilities affecting endpoints, cloud resources, identities, and applications. Vulnerability severity is dynamically scored and prioritized based on contextual factors including compensating security controls, exploitability likelihood, temporal exposure factors, and asset importance.

Further disclosed embodiments incorporate cyber asset attack surface management (CAASM), systematically maintaining a comprehensive inventory of assets across the enterprise. This inventory includes detailed contextual metadata—such as ownership, software versions, operational configurations, cloud service details, and presence or absence of required security controls—to facilitate rapid identification and remediation of coverage gaps, unmanaged or rogue assets, and configuration inconsistencies.

Additional embodiments implement continuous threat exposure management (CTEM) by ingesting near real-time telemetry, event logs, and exposure-related data, updating the semantically harmonized representation continuously, and dynamically recalculating risk posture based on the timeliness and criticality of data. CTEM embodiments further enable the tracing of potential attack paths through graph-based analytics, identifying critical exposure points and proactively initiating remediation workflows.

Yet other embodiments focus specifically on asset exposure management (AEM), wherein the exposure status of each asset is assessed based on its configuration state, installed security tools, observed vulnerabilities, asset criticality, and user behavioral risks. Assets identified as critical and exposed trigger prioritized remediation workflows, which may include updating the CMDB, restricting network access, enforcing software updates, assigning responsible parties for remediation, and alerting security teams of high-risk scenarios.

Collectively, these embodiments deliver comprehensive, integrated exposure and attack surface management by unifying data from heterogeneous sources and cybersecurity monitoring systems into a semantically harmonized representation, enabling real-time, context-aware computation of organizational risk posture and facilitating proactive, prioritized, and automated remediation workflows to reduce cybersecurity exposure.

### CONCLUSION

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner—whether collectively, in subsets, or individually—thereby broadening the range of potential embodiments.

What is claimed is:

1. A method for continuous exposure management in a computing environment, comprising:
ingesting cybersecurity data from a plurality of heterogeneous sources into a data fabric, wherein the sources comprise cybersecurity monitoring systems, cloud service providers, configuration management databases (CMDBs), and endpoint telemetry feeds;
normalizing and correlating the ingested data into a semantically harmonized representation using a security knowledge graph implemented in the data fabric, the representation comprising entities including users, devices, applications, vulnerabilities, misconfigurations, or policies;
continuously evaluating harmonized data in the security knowledge graph to detect potential exposures based on predefined controls and graph traversal logic;
generating a risk posture by aggregating exposure metrics associated with entities in the security knowledge graph, wherein the risk posture is dynamically updated in response to newly ingested data; and
triggering automated remediation workflows based on policy-defined thresholds, wherein the workflows are executed in response to detected exposures to reduce an attack surface of the computing environment.

2. The method of claim 1, further comprising ingesting vulnerability data from a plurality of scanners and threat intelligence sources, and correlating the vulnerability data with asset inventory and contextual telemetry.

3. The method of claim 1, wherein exposure data includes detection of external-facing assets lacking authentication, use of insecure protocols, or misconfigured firewall rules.

4. The method of claim 1, further comprising generating a topological map of the attack surface using the security knowledge graph, showing relationships between assets, identities, and vulnerabilities.

5. The method of claim 1, wherein the risk posture is segmented by zone, region, or application group, and exposure scores are computed per segment.

6. The method of claim 1, further comprising generating exposure reports and visual dashboards showing trends over time and surfacing emerging high-risk asset clusters.

7. The method of claim 1, wherein the continuously evaluating includes continuous scanning for threats, misconfigurations, and vulnerabilities across the computing environment.

8. The method of claim 7, further comprising identifying high-risk exposure paths based on graph traversal between vulnerable assets and sensitive data stores on the security knowledge graph.

9. The method of claim 7, wherein prioritization of remediation is based on attack likelihood computed using threat intelligence, exploitability, and exposure window duration.

10. The method of claim 7, further comprising updating risk posture metrics at defined intervals based on telemetry, scan frequency, and new threat signatures.

11. The method of claim 1, wherein the data fabric aggregates asset metadata from security and IT management tools to construct a unified asset inventory.

12. The method of claim 11, further comprising deduplicating assets using a multi-source matching process and generating an uber node representing each asset.

13. The method of claim 1, wherein the data fabric correlates exposure indicators with asset criticality to identify exposed or misconfigured assets.

14. The method of claim 13, further comprising applying policy-driven remediation such as access restriction, ticket generation, or CMDB update for exposed assets.

15. The method of claim 13, wherein asset exposure is calculated based on absence of endpoint protection, deviation from policy baselines, or known misconfigurations.

16. The method of claim 13, further comprising triggering dynamic updates to CMDB records to resolve gaps and discrepancies in asset metadata.

17. A system for continuous exposure management in a computing environment, comprising:
one or more processors and memory storing instructions that, when executed, cause the one or more processors to:
ingest cybersecurity data from a plurality of heterogeneous sources into a data fabric, wherein the sources comprise cybersecurity monitoring systems, cloud service providers, configuration management databases (CMDBs), and endpoint telemetry feeds;
normalize and correlate the ingested data into a semantically harmonized representation using a security knowledge graph implemented in the data fabric, the representation comprising entities including users, devices, applications, vulnerabilities, misconfigurations, or policies;
continuously evaluate harmonized data in the security knowledge graph to detect potential exposures based on predefined controls and graph traversal logic;
generate a risk posture by aggregating exposure metrics associated with entities in the security knowledge graph, wherein the risk posture is dynamically updated in response to newly ingested data; and
trigger automated remediation workflows based on policy-defined thresholds, wherein the workflows are executed in response to detected exposures to reduce an attack surface of the computing environment.

18. The system of claim 17, wherein the instructions that, when executed, cause the one or more processors to:
ingest vulnerability data from a plurality of scanners and threat intelligence sources, and correlating the vulnerability data with asset inventory and contextual telemetry.

19. The system of claim 17, wherein the instructions that, when executed, cause the one or more processors to:
generate a topological map of the attack surface using the security knowledge graph, showing relationships between assets, identities, and vulnerabilities.

20. The system of claim 17, wherein the instructions that, when executed, cause the one or more processors to:
generate exposure reports and visual dashboards showing trends over time and surfacing emerging high-risk asset clusters.
